(19) United States
(12) Patent Application Publication
(10) Pub. No.: US 2024/0276484 A1
(43) Pub. Date: Aug. 15, 2024

(54) TECHNIQUES FOR COMMUNICATING UPLINK TRAFFIC VIA CONFIGURED GRANT PERIODS WITH MULTIPLE SHARED CHANNEL OCCASIONS

(71) Applicant: QUALCOMM Incorporated, San Diego, CA (US)

(72) Inventors: Huilin Xu, Temecula, CA (US); Jing Sun, San Diego, CA (US)

(21) Appl. No.: 18/168,411

(22) Filed: Feb. 13, 2023

(51) Int. Cl. H04W 72/1268

(52) U.S. Cl. CPC H04W 72/1268

(57) ABSTRACT

Methods, systems, and devices for wireless communications are described. In some systems, a user equipment (UE) and a network entity may support one or more mechanisms according to which the UE and the network entity may avoid glitches in latency-sensitive traffic and reduce ambiguity relating to scheduling and resource use expectations for configured grant (CG) periods including multiple shared channel occasions. Such mechanisms may include a rule according to which the UE and the network entity expect spans of shared channel occasions within different CG periods to avoid overlapping in time. The rule may preclude any time domain overlapping between spans of shared channel occasions within different CG periods or may allow for a time domain overlapping between spans of shared channel occasions within different CG periods and instead indicate how a UE is expected to use shared channel occasions of overlapping spans of shared channel occasions.

### FIELD OF DISCLOSURE

The following relates to wireless communications, including techniques for communicating uplink traffic via configured grant (CG) periods with multiple shared channel occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The present disclosure relates to improved methods, systems, devices, and apparatuses that support techniques for communicating uplink traffic via configured grant (CG) periods with multiple shared channel occasions. For example, the present disclosure provides for how a user equipment (UE) may receive configuration information associated with an uplink CG that includes or otherwise provides multiple physical uplink shared channel (PUSCH) occasions during each period of the uplink CG (where such periods of a CG may be referred to as CG periods). In some implementations, the UE and the network entity may use one or more multi-PUSCH occasion CGs to support various data generation periodicities at the UE and may further support one or more rules (e.g., mutually understood expectations) associated with how the UE operates in scenarios in which spans of PUSCH occasions of different CG periods overlap in time.

A method for wireless communication at a UE is described. The method may include receiving control signaling associated with one or more uplink CGs usable by the UE, the one or more uplink CGs including a first set of uplink shared channel transmission occasions within a first CG period and a second set of uplink shared channel transmission occasions within a second CG period and transmitting, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

An apparatus for wireless communication at a UE is described. The apparatus may include a processor, memory coupled with the processor, and instructions stored in the memory. The instructions may be executable by the processor to cause the apparatus to receive control signaling associated with one or more uplink CGs usable by the UE, the one or more uplink CGs including a first set of uplink shared channel transmission occasions within a first CG period and a second set of uplink shared channel transmission occasions within a second CG period and transmit, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

Another apparatus for wireless communication at a UE is described. The apparatus may include means for receiving control signaling associated with one or more uplink CGs usable by the UE, the one or more uplink CGs including a first set of uplink shared channel transmission occasions within a first CG period and a second set of uplink shared channel transmission occasions within a second CG period and means for transmitting, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

A non-transitory computer-readable medium storing code for wireless communication at a UE is described. The code may include instructions executable by a processor to receive control signaling associated with one or more uplink CGs usable by the UE, the one or more uplink CGs including a first set of uplink shared channel transmission occasions within a first CG period and a second set of uplink shared channel transmission occasions within a second CG period and transmit, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

Some examples of the method, apparatuses, and non-transitory computer-readable medium described herein may further include operations, features, means, or instructions for receiving, via the control signaling, an indication of a first time domain resource allocation associated with the first set of uplink shared channel transmission occasions and a second time domain resource allocation associated with the second set of uplink shared channel transmission occasions, where the first span may be associated with the first time domain resource allocation and the second span may be associated with the second time domain resource allocation and skipping an uplink shared channel transmission occasion of the first set of uplink shared channel transmission occasions in accordance with the uplink shared channel transmission occasion overlapping in time with the second span of the second set of uplink shared channel transmission occasions.

In some examples of the method, apparatuses, and non-transitory computer-readable medium described herein, skipping the uplink shared channel transmission occasion of the first set of uplink shared channel transmission occasions may include operations, features, means, or instructions for skipping the uplink shared channel transmission occasion of the first set of uplink shared channel transmission occasions in accordance with the first span of the first set of uplink shared channel transmission occasions being associated with an earlier start time than the second span of the second set of uplink shared channel transmission occasions.

In some examples of the method, apparatuses, and non-transitory computer-readable medium described herein, skipping the uplink shared channel transmission occasion of the first set of uplink shared channel transmission occasions may include operations, features, means, or instructions for skipping the uplink shared channel transmission occasion of the first set of uplink shared channel transmission occasions in accordance with the first span of the first set of uplink shared channel transmission occasions being associated with a later start time than the second span of the second set of uplink shared channel transmission occasions.

In some examples of the method, apparatuses, and non-transitory computer-readable medium described herein, receiving the control signaling may include operations, features, means, or instructions for receiving information associated with the one or more uplink CGs in accordance with a time domain overlapping rule, where the time domain overlapping rule may be indicative of an expectation that spans of sets of uplink shared channel transmission occasions within different CG periods avoid overlapping in time.

In some examples of the method, apparatuses, and non-transitory computer-readable medium described herein, the time domain overlapping rule may be applied on a per-transmission and reception point (TRP) basis.

In some examples of the method, apparatuses, and non-transitory computer-readable medium described herein, the first span may be a time duration between a starting point of an initial uplink shared channel transmission occasion of the first set of uplink shared channel transmission occasions and an ending point of a final uplink shared channel transmission occasion of the first set of uplink shared channel transmission occasions, and the second span may be a time duration between a starting point of an initial uplink shared channel transmission occasion of the second set of uplink shared channel transmission occasions and an ending point of a final uplink shared channel transmission occasion of the second set of uplink shared channel transmission occasions and the first set of uplink shared channel transmission occasions may be periodically available to the UE in accordance with the first CG period and the second set of uplink shared channel transmission occasions may be periodically available to the UE in accordance with the second CG period.

In some examples of the method, apparatuses, and non-transitory computer-readable medium described herein, the first span and the second span may be associated with a same CG.

In some examples of the method, apparatuses, and non-transitory computer-readable medium described herein, the first span and the second span may be associated with different CGs.

In some examples of the method, apparatuses, and non-transitory computer-readable medium described herein, the first span includes all repetitions of uplink shared channel transmission occasions within the first CG period and the second span includes all repetitions of uplink shared channel transmission occasions within the second CG period.

Some examples of the method, apparatuses, and non-transitory computer-readable medium described herein may further include operations, features, means, or instructions for receiving, via the control signaling, an indication that the first set of uplink shared channel transmission occasions may be associated with a first CG and the second set of uplink shared channel transmission occasions may be associated with a second CG, where the first CG period and the second CG period partially overlap to create an effective CG period shorter than each of the first CG period and the second CG period, generating the first data packet and the second data packet in accordance with the effective CG period, and transmitting the first data packet via the first set of uplink shared channel transmission occasions and the second data packet via the second set of uplink shared channel transmission occasions in accordance with the effective CG period.

In some examples of the method, apparatuses, and non-transitory computer-readable medium described herein, transmitting the first data packet and the second data packet may include operations, features, means, or instructions for transmitting respective portions of the first data packet via respective uplink shared channel transmission occasions of the first set of uplink shared channel transmission occasions and transmitting respective portions of the second data packet via respective uplink shared channel transmission occasions of the second set of uplink shared channel transmission occasions.

Some examples of the method, apparatuses, and non-transitory computer-readable medium described herein may further include operations, features, means, or instructions for calculating a starting symbol associated with an uplink shared channel occasion of the first set of uplink shared channel transmission occasions or the second set of uplink shared channel transmission occasions in accordance with a dedicated range of system frame number (SFN) values, where the dedicated range of SFN values may be a multiple of a duration of the first CG period or the second CG period, respectively.

Some examples of the method, apparatuses, and non-transitory computer-readable medium described herein may further include operations, features, means, or instructions for calculating a starting symbol associated with an uplink shared channel occasion of the first set of uplink shared channel transmission occasions or the second set of uplink shared channel transmission occasions in accordance with increasing or decreasing the starting symbol by a dedicated value each time an SFN resets from a maximum value to a minimum value, where the dedicated value may be based on a modulo operation of the maximum value by a duration of the first CG period or the second CG period.

A method for wireless communication at a network entity is described. The method may include transmitting control signaling associated with one or more uplink CGs usable by a UE, the one or more uplink CGs including a first set of uplink shared channel transmission occasions within a first CG period and a second set of uplink shared channel transmission occasions within a second CG period and receiving, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

An apparatus for wireless communication at a network entity is described. The apparatus may include a processor, memory coupled with the processor, and instructions stored in the memory. The instructions may be executable by the processor to cause the apparatus to transmit control signaling associated with one or more uplink CGs usable by a UE, the one or more uplink CGs including a first set of uplink shared channel transmission occasions within a first CG period and a second set of uplink shared channel transmission occasions within a second CG period and receive, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

Another apparatus for wireless communication at a network entity is described. The apparatus may include means for transmitting control signaling associated with one or more uplink CGs usable by a UE, the one or more uplink CGs including a first set of uplink shared channel transmission occasions within a first CG period and a second set of uplink shared channel transmission occasions within a second CG period and means for receiving, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

A non-transitory computer-readable medium storing code for wireless communication at a network entity is described. The code may include instructions executable by a processor to transmit control signaling associated with one or more uplink CGs usable by a UE, the one or more uplink CGs including a first set of uplink shared channel transmission occasions within a first CG period and a second set of uplink shared channel transmission occasions within a second CG period and receive, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

Some examples of the method, apparatuses, and non-transitory computer-readable medium described herein may further include operations, features, means, or instructions for transmitting, via the control signaling, an indication of a first time domain resource allocation associated with the first set of uplink shared channel transmission occasions and a second time domain resource allocation associated with the second set of uplink shared channel transmission occasions, where the first span may be associated with the first time domain resource allocation and the second span may be associated with the second time domain resource allocation and allocating, to a device different from the UE, an uplink shared channel transmission occasion of the first set of uplink shared channel transmission occasions in accordance with the uplink shared channel transmission occasion overlapping in time with the second span of the second set of uplink shared channel transmission occasions.

In some examples of the method, apparatuses, and non-transitory computer-readable medium described herein, allocating the uplink shared channel transmission occasion of the first set of uplink shared channel transmission occasions to the device different from the UE may include operations, features, means, or instructions for allocating the uplink shared channel transmission occasion of the first set of uplink shared channel transmission occasions in accordance with the first span of the first set of uplink shared channel transmission occasions being associated with an earlier start time than the second span of the second set of uplink shared channel transmission occasions.

In some examples of the method, apparatuses, and non-transitory computer-readable medium described herein, allocating the uplink shared channel transmission occasion of the first set of uplink shared channel transmission occasions to the device different from the UE may include operations, features, means, or instructions for allocating the uplink shared channel transmission occasion of the first set of uplink shared channel transmission occasions in accordance with the first span of the first set of uplink shared channel transmission occasions being associated with a later start time than the second span of the second set of uplink shared channel transmission occasions.

In some examples of the method, apparatuses, and non-transitory computer-readable medium described herein, transmitting the control signaling may include operations, features, means, or instructions for transmitting information associated with the one or more uplink CGs in accordance with a time domain overlapping rule, where the time domain overlapping rule may be indicative of an expectation that spans of sets of uplink shared channel transmission occasions within different CG periods avoid overlapping in time.

In some examples of the method, apparatuses, and non-transitory computer-readable medium described herein, the time domain overlapping rule may be applied on a per-TRP basis.

In some examples of the method, apparatuses, and non-transitory computer-readable medium described herein, the first span may be a time duration between a starting point of an initial uplink shared channel transmission occasion of the first set of uplink shared channel transmission occasions and an ending point of a final uplink shared channel transmission occasion of the first set of uplink shared channel transmission occasions, and the second span may be a time duration between a starting point of an initial uplink shared channel transmission occasion of the second set of uplink shared channel transmission occasions and an ending point of a final uplink shared channel transmission occasion of the second set of uplink shared channel transmission occasions and the first set of uplink shared channel transmission occasions may be periodically available to the UE in accordance with the first CG period and the second set of uplink shared channel transmission occasions may be periodically available to the UE in accordance with the second CG period.

In some examples of the method, apparatuses, and non-transitory computer-readable medium described herein, the first span and the second span may be associated with a same CG.

In some examples of the method, apparatuses, and non-transitory computer-readable medium described herein, the first span and the second span may be associated with different CGs.

In some examples of the method, apparatuses, and non-transitory computer-readable medium described herein, the first span includes all repetitions of uplink shared channel transmission occasions within the first CG period and the second span includes all repetitions of uplink shared channel transmission occasions within the second CG period.

Some examples of the method, apparatuses, and non-transitory computer-readable medium described herein may further include operations, features, means, or instructions for transmitting, via the control signaling, an indication that the first set of uplink shared channel transmission occasions may be associated with a first CG and the second set of uplink shared channel transmission occasions may be associated with a second CG, where the first CG period and the second CG period partially overlap to create an effective CG period shorter than each of the first CG period and the second CG period, and where a duration of the effective CG period may be based on a data generation frequency at the UE and receiving the first data packet via the first set of uplink shared channel transmission occasions and the second data packet via the second set of uplink shared channel transmission occasions in accordance with the effective CG period.

In some examples of the method, apparatuses, and non-transitory computer-readable medium described herein, receiving the first data packet and the second data packet may include operations, features, means, or instructions for receiving respective portions of the first data packet via respective uplink shared channel transmission occasions of the first set of uplink shared channel transmission occasions and receiving respective portions of the second data packet via respective uplink shared channel transmission occasions of the second set of uplink shared channel transmission occasions.

Some examples of the method, apparatuses, and non-transitory computer-readable medium described herein may further include operations, features, means, or instructions for calculating a starting symbol associated with an uplink shared channel occasion of the first set of uplink shared channel transmission occasions or the second set of uplink shared channel transmission occasions in accordance with a dedicated range of SFN values, where the dedicated range of SFN values may be a multiple of a duration of the first CG period or the second CG period, respectively.

Some examples of the method, apparatuses, and non-transitory computer-readable medium described herein may further include operations, features, means, or instructions for calculating a starting symbol associated with an uplink shared channel occasion of the first set of uplink shared channel transmission occasions or the second set of uplink shared channel transmission occasions in accordance with increasing or decreasing the starting symbol by a dedicated value each time an SFN resets from a maximum value to a minimum value, where the dedicated value may be based on a modulo operation of the maximum value by a duration of the first CG period or the second CG period.

### BRIEF DESCRIPTION OF THE DRAWINGS

FIG. 1 illustrates an example of a wireless communications system that supports techniques for communicating uplink traffic via configured grant (CG) periods with multiple shared channel occasions in accordance with various aspects of the present disclosure.

FIG. 2 illustrates an example of a network architecture that supports techniques for communicating uplink traffic via CG periods with multiple shared channel occasions in accordance with various aspects of the present disclosure.

FIG. 3 illustrates an example of a signaling diagram that supports techniques for communicating uplink traffic via CG periods with multiple shared channel occasions in accordance with various aspects of the present disclosure.

FIG. 4 illustrates an example of a set of multi-PUSCH CG configurations that support techniques for communicating uplink traffic via CG periods with multiple shared channel occasions in accordance with various aspects of the present disclosure.

FIGS. 5 and 6 illustrate examples of communication timelines that support techniques for communicating uplink traffic via CG periods with multiple shared channel occasions in accordance with various aspects of the present disclosure.

FIG. 7 illustrates an example of a process flow that supports techniques for communicating uplink traffic via CG periods with multiple shared channel occasions in accordance with various aspects of the present disclosure.

FIGS. 8 and 9 illustrate block diagrams of devices that support techniques for communicating uplink traffic via CG periods with multiple shared channel occasions in accordance with various aspects of the present disclosure.

FIG. 10 illustrates a block diagram of a communications manager that supports techniques for communicating uplink traffic via CG periods with multiple shared channel occasions in accordance with various aspects of the present disclosure.

FIG. 11 illustrates a diagram of a system including a device that supports techniques for communicating uplink traffic via CG periods with multiple shared channel occasions in accordance with various aspects of the present disclosure.

FIGS. 12 and 13 illustrate block diagrams of devices that support techniques for communicating uplink traffic via CG periods with multiple shared channel occasions in accordance with various aspects of the present disclosure.

FIG. 14 illustrates a block diagram of a communications manager that supports techniques for communicating uplink traffic via CG periods with multiple shared channel occasions in accordance with various aspects of the present disclosure.

FIG. 15 illustrates a diagram of a system including a device that supports techniques for communicating uplink traffic via CG periods with multiple shared channel occasions in accordance with various aspects of the present disclosure.

FIGS. 16 and 17 illustrate flowcharts showing methods that support techniques for communicating uplink traffic via CG periods with multiple shared channel occasions in accordance with various aspects of the present disclosure.

### DETAILED DESCRIPTION

In some wireless communications systems, a user equipment (UE) may support various types of applications, where different types of applications may be associated with different data rates at the UE. For applications associated with regular, periodic, or otherwise relatively consistent (e.g., predictable) data generation at the UE, a network entity may configure the UE with an uplink configured grant (CG), which may include or provide physical uplink shared channel (PUSCH) occasions to the UE periodically (without relying on frequent downlink control information (DCI)-based scheduling). In some cases, an uplink CG may be associated with one PUSCH occasion per CG period, which may be relatively more suitable for periodic uplink traffic with relatively smaller data packet sizes. In some other cases, an uplink CG may be associated with multiple PUSCH occasions per CG period, which may be relatively more suitable for periodic uplink traffic with relatively larger data packet sizes. Multi-PUSCH occasion CG periods, however, may present scheduling challenges or may be associated with discrepancies between CG periodicity and a periodicity of uplink data generation at the UE. As such, in some scenarios, devices using multi-PUSCH occasion CG periods may experience glitches in latency-sensitive traffic or may experience ambiguity relating to scheduling and resource use expectations for PUSCH occasions within a multi-PUSCH occasion CG period.

In some implementations, a UE and a network entity may support one or more signaling- or configuration-based mechanisms according to which the UE and the network entity may avoid glitches in latency-sensitive traffic and reduce ambiguity relating to scheduling and resource use expectations for PUSCH occasions within a multi-PUSCH occasion CG period across various deployment scenarios and use cases. In some examples, such one or more signaling- or configuration-based mechanisms may include or be associated with a rule according to which the UE and the network entity expect spans of PUSCH occasions within different CG periods to avoid overlapping in the time domain (where a span of PUSCH occasions may refer to a time duration from a start of a first PUSCH occasion within a CG period to an end of a last PUSCH occasion within the CG period). In such examples, the rule may apply to an initial configuration or activation of uplink CGs or may apply to how configured or activated uplink CGs are used. In other words, the rule may preclude any time domain overlapping between spans of PUSCH occasions within different CG periods or may allow for a time domain overlapping between spans of PUSCH occasions within different CG periods and instead indicate how a UE is expected to use PUSCH occasions of overlapping spans of PUSCH occasions.

For example, if a first span of PUSCH occasions within a first CG period at least partially overlaps in time with a second span of PUSCH occasions within a second CG period (where such first and second CG periods may be associated with a same uplink CG or different uplink CGs), the rule may indicate how the UE is expected to skip one or more PUSCH occasions of either the first or second span of PUSCH occasions. Additionally, or alternatively, the one or more signaling- or configuration-based mechanisms may include or be associated with a configuration or activation of multiple uplink CGs simultaneously, where each of the multiple uplink CGs include or provide multiple PUSCH occasions per CG period. In some examples, a network entity may offset (e.g., stagger) multiple concurrently configured or activated multi-PUSCH occasion uplink CGs in time to achieve or create an effective periodicity that is based on (e.g., adapted or equal to) a rate of data generation at the UE. Additionally, or alternatively, the one or more signaling- or configuration-based mechanisms may include or be associated with a calculation of a starting symbol index for a PUSCH occasion of a multi-PUSCH occasion CG based on a periodicity of the multi-PUSCH occasion CG.

The implementations of the subject matter described in this disclosure can be implemented to realize one or more of the following potential advantages. For example, in accordance with (e.g., as a result of) supporting a rule according to which overlapping spans of PUSCH occasions within different CG periods is precluded or otherwise addressed, a UE and a network entity may achieve a mutual understanding relating to scheduling constraints or how each device expects any overlapping PUSCH occasions to be used. As such, the UE and the network entity may achieve greater synchronization in terms of expectations associated with resource allocation and, accordingly, may support greater system capacity and spectral efficiency. Further, in accordance with (e.g., as a result of) configuring or activating multiple multi-PUSCH occasion uplink CGs with some level of staggering, the network entity may adapt a periodic resource allocation to the UE based on a periodicity of data generation (e.g., relatively large packet size data generation) at the UE. As such, the UE and the network entity may experience higher data rates and lower latency, which may improve a user experience. Moreover, in accordance with (e.g., as a result of) supporting a starting symbol calculation based on a periodicity of a multi-PUSCH occasion CG, the UE and the network entity may avoid glitches in latency-sensitive traffic and maintain better alignment between UE data generation and PUSCH occasion availability over time, which also may lower latency and improve a user experience.

Aspects of the disclosure are initially described in the context of wireless communications systems. Aspects of the disclosure are additionally illustrated by and described with reference to a signaling diagram, a set of multi-PUSCH CG configurations, communication timelines, and a process flow. Aspects of the disclosure are further illustrated by and described with reference to apparatus diagrams, system diagrams, and flowcharts that relate to techniques for communicating uplink traffic via CG periods with multiple shared channel occasions.

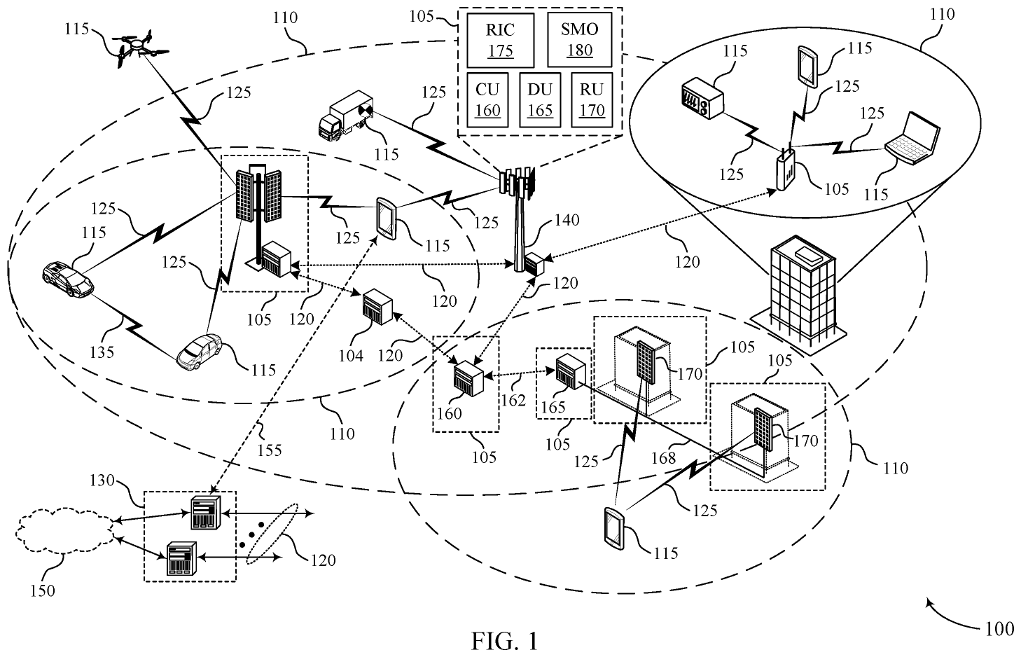

FIG. 1 illustrates an example of a wireless communications system 100 that supports techniques for communicating uplink traffic via CG periods with multiple shared channel occasions in accordance with various aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for communicating uplink traffic via CG periods with multiple shared channel occasions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology (e.g., an unlicensed radio frequency spectrum band technology), or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along specific orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a specific orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE 115 and a network entity 105 may support one or more signaling- or configuration-based mechanisms according to which the UE 115 and the network entity 105 may avoid glitches in latency-sensitive traffic and reduce ambiguity relating to scheduling and resource use expectations for PUSCH occasions within a multi-PUSCH occasion CG period across various deployment scenarios and use cases. In some examples, such one or more signaling- or configuration-based mechanisms may include or be associated with a rule according to which the UE 115 and the network entity 105 expect spans of PUSCH occasions within different CG periods to avoid overlapping in the time domain. In such examples, the rule may apply to an initial configuration or activation of uplink CGs or may apply to how configured or activated uplink CGs are used.

In other words, the rule may preclude any time domain overlapping between spans of PUSCH occasions within different CG periods or may allow for a time domain overlapping between spans of PUSCH occasions within different CG periods and instead indicate how a UE 115 is expected to use PUSCH occasions of overlapping spans of PUSCH occasions (where a span of PUSCH occasions may refer to a time duration from a start of a first PUSCH occasion within a CG period to an end of a last PUSCH occasion within the CG period). For example, if a first span of PUSCH occasions within a first CG period at least partially overlaps in time with a second span of PUSCH occasions within a second CG period (where such first and second CG periods may be associated with a same uplink CG or different uplink CGs), the rule may indicate how the UE 115 is expected to skip one or more PUSCH occasions of either the first or second span of PUSCH occasions.

Additionally, or alternatively, the one or more signaling- or configuration-based mechanisms may include or be associated with a configuration or activation of multiple uplink CGs simultaneously, where each of the multiple uplink CGs include or provide multiple PUSCH occasions per CG period. In some examples, a network entity 105 may offset (e.g., stagger) multiple concurrently configured or activated multi-PUSCH occasion uplink CGs in time to achieve or create an effective periodicity that is shorter than a periodicity of any one of the multiple uplink CGs alone. Additionally, or alternatively, the one or more signaling- or configuration-based mechanisms may include or be associated with a calculation of a starting symbol index for a PUSCH occasion of a multi-PUSCH occasion CG based on a periodicity of the multi-PUSCH occasion CG.

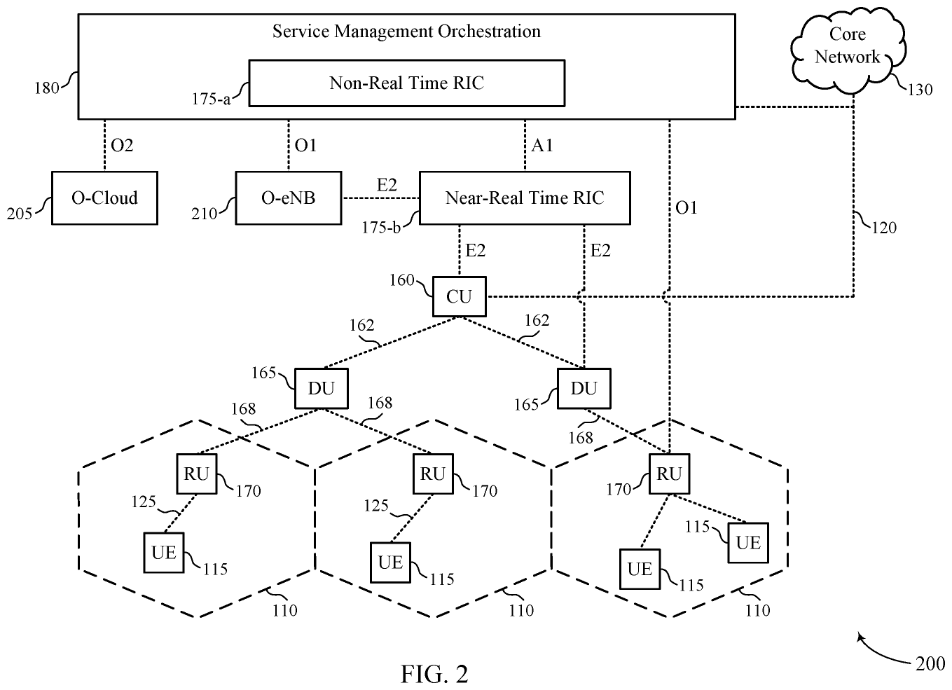

FIG. 2 illustrates an example of a network architecture 200 (e.g., a disaggregated base station architecture, a disaggregated RAN architecture) that supports techniques for communicating uplink traffic via CG periods with multiple shared channel occasions in accordance with various aspects of the present disclosure. The network architecture 200 may illustrate an example for implementing one or more aspects of the wireless communications system 100. The network architecture 200 may include one or more CUs 160 that may communicate directly with a core network 130 via a backhaul communication link 120, or indirectly with the core network 130 through one or more disaggregated network entities 105 (e.g., a Near-RT RIC 175-b via an E2 link, or a Non-RT RIC 175-a associated with an SMO 180 (e.g., an SMO Framework), or both). A CU 160 may communicate with one or more DUs 165 via respective midhaul communication links 162 (e.g., an F1 interface). The DUs 165 may communicate with one or more RUs 170 via respective fronthaul communication links 168. The RUs 170 may be associated with respective coverage areas 110 and may communicate with UEs 115 via one or more communication links 125. In some implementations, a UE 115 may be simultaneously served by multiple RUs 170.

Each of the network entities 105 of the network architecture 200 (e.g., CUs 160, DUs 165, RUs 170, Non-RT RICs 175-a, Near-RT RICs 175-b, SMOs 180, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160 may host one or more higher layer control functions. Such control functions may include RRC, PDCP, SDAP, or the like. Each control function may be implemented with an interface configured to communicate signals with other control functions hosted by the CU 160. A CU 160 may be configured to handle user plane functionality (e.g., CU-UP), control plane functionality (e.g., CU-CP), or a combination thereof. In some examples, a CU 160 may be logically split into one or more CU-UP units and one or more CU-CP units. A CU-UP unit may communicate bidirectionally with the CU-CP unit via an interface, such as an E1 interface when implemented in an O-RAN configuration. A CU 160 may be implemented to communicate with a DU 165, as necessary, for network control and signaling.

A DU 165 may correspond to a logical unit that includes one or more functions (e.g., base station functions, RAN functions) to control the operation of one or more RUs 170. In some examples, a DU 165 may host, at least partially, one or more of an RLC layer, a MAC layer, and one or more aspects of a PHY layer (e.g., a high PHY layer, such as components for FEC encoding and decoding, scrambling, modulation and demodulation, or the like) depending, at least in part, on a functional split, such as those defined by the 3rd Generation Partnership Project (3GPP). In some examples, a DU 165 may further host one or more low PHY layers. Each layer may be implemented with an interface configured to communicate signals with other layers hosted by the DU 165, or with control functions hosted by a CU 160.

In some examples, lower-layer functionality may be implemented by one or more RUs 170. For example, an RU 170, controlled by a DU 165, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170 may be implemented to handle over the air (OTA) communication with one or more UEs 115. In some implementations, real-time and non-real-time aspects of control and user plane communication with the RU(s) 170 may be controlled by the corresponding DU 165. In some examples, such a configuration may enable a DU 165 and a CU 160 to be implemented in a cloud-based RAN architecture, such as a vRAN architecture.

The SMO 180 may be configured to support RAN deployment and provisioning of non-virtualized and virtualized network entities 105. For non-virtualized network entities 105, the SMO 180 may be configured to support the deployment of dedicated physical resources for RAN coverage requirements which may be managed via an operations and maintenance interface (e.g., an O1 interface). For virtualized network entities 105, the SMO 180 may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160, DUs 165, RUs 170, and Near-RT RICs 175-b. In some implementations, the SMO 180 may communicate with components configured in accordance with a 4G RAN (e.g., via an O1 interface). Additionally, or alternatively, in some implementations, the SMO 180 may communicate directly with one or more RUs 170 via an O1 interface. The SMO 180 also may include a Non-RT RIC 175-a configured to support functionality of the SMO 180.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160, one or more DUs 165, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180 or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180 (e.g., reconfiguration via 01) or via generation of RAN management policies (e.g., A1 policies).

In some implementations, a UE 115 and a network entity 105 may support one or more signaling- or configuration-based mechanisms according to which the UE 115 and the network entity 105 may avoid glitches in latency-sensitive traffic and reduce ambiguity relating to scheduling and resource use expectations for PUSCH occasions within a multi-PUSCH occasion CG period across various deployment scenarios and use cases. In some examples, such one or more signaling- or configuration-based mechanisms may include or be associated with a rule according to which the UE 115 and the network entity 105 expect spans of PUSCH occasions within different CG periods to avoid overlapping in the time domain. In such examples, the rule may apply to an initial configuration or activation of uplink CGs or may apply to how configured or activated uplink CGs are used. In some implementations, the UE 115 and the network entity 105 may apply such mechanisms or rules on a per-TRP basis. For example, the UE 115 may apply such mechanisms or rules for first communications between the UE 115 and a first TRP and may separately apply such mechanisms or rules for second communications between the UE 115 and a second TRP.

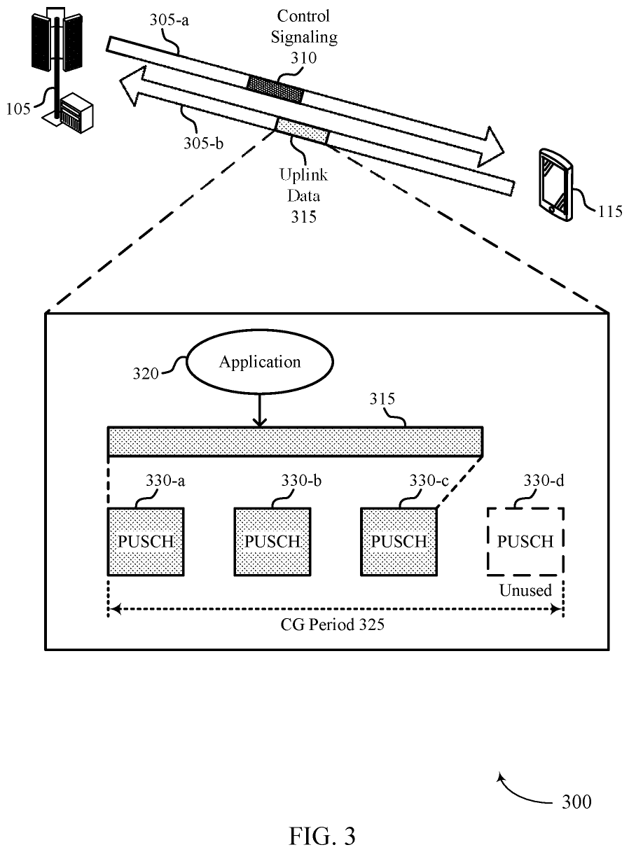

FIG. 3 illustrates an example of a signaling diagram 300 that supports techniques for communicating uplink traffic via CG periods with multiple shared channel occasions in accordance with various aspects of the present disclosure. The signaling diagram 300 illustrates communication between a UE 115 and a network entity 105 via a downlink 305-a and an uplink 305-b, where the UE 115 and the network entity 105 may be examples of corresponding devices illustrated by and described with reference to FIGS. 1 and 2.

The UE 115 and the network entity 105 may support various types of uplink CGs, including uplink CGs that are configured (e.g., RRC configured) and active thereafter and uplink CGs that are configured and activated via a subsequent activation DCI, or both. Further, the UE 115 and the network entity 105 may support uplink CGs that include or provide a single PUSCH occasion per CG period or uplink CGs that include or provide multiple PUSCH occasions per CG period. An uplink CG that includes or provides a single PUSCH occasion per CG period may be relatively more suitable for periodic uplink traffic with relatively small size packets, such as voice, control message for industrial internet-of-things (IIoT), or pose for an extended reality (XR) application. An uplink CG that includes or provides multiple PUSCH occasions per CG period (e.g., a CG occasion configured with multiple PUSCH occasions) may be relatively more suitable for periodic uplink traffic with relatively large size packets, such as video traffic generated by a user application (e.g., a video surveillance camera, an augmented reality (AR) scene, etc.). Support for an uplink CG that includes multiple PUSCH occasions per CG period may be equivalently understood as support for multiple CG PUSCH transmission occasions in a period of a single CG PUSCH configuration to handle such periodic uplink traffic.

A CG period with multiple PUSCH occasions may be associated with various configuration or design considerations. In some aspects, for example, multiple PUSCH occasions within a CG period may be allocated to consecutive or non-consecutive slots. In some aspects, the network entity 105 may use a multi-PUSCH scheduling DCI to activate a multi-PUSCH occasion CG configuration. In such aspects, a quantity of PUSCH occasions may be the same as a quantity of start and length indicator values (SLIVs) indicated by a time domain resource assignment for the CG configuration. In some aspects, some information, such as a frequency resource assignment or a modulation and coding scheme (MCS), may be shared by the PUSCHs within a CG period. In some aspects, the UE 115 or the network entity 105, or both, may determine a HARQ identifier for a CG period, may assign the HARQ identifier to a first (e.g., initial) PUSCH occasion within the CG period, and may increment the HARQ identifier for each subsequent PUSCH occasion within the CG period.

As illustrated in the example of FIG. 3, the UE 115 may receive control signaling 310 associated with one or more uplink CG configurations, where such control signaling 310 may include or be an example of RRC signaling, DCI messaging, one or more MAC control elements (MAC-CEs), or any combination thereof. As such, the control signaling 310 may configure or activate one or more uplink CG configurations, or both configure and activate one or more uplink CG configurations. The UE 115 may use the one or more uplink CG configurations to transmit (periodic) uplink data 315 to the network entity 105, which may include uplink data 315 associated with an application 320 at the UE 115. As such, the UE 115 may generate the uplink data 315 based on the application 320 at the UE 115 and may transmit the uplink data 315 via periodically occurring PUSCH occasions in accordance with an uplink CG configuration provided by the control signaling 310.

In some cases, the uplink CG configuration may be associated with a CG period 325 and may include or provide multiple PUSCH occasions per CG period 325. For instance, in the example of FIG. 3, a CG period 325 may include a PUSCH occasion 330-a, a PUSCH occasion 330-b, a PUSCH occasion 330-c, and a PUSCH occasion 330-d. As such, the UE 115 may generate the uplink data 315 (e.g., data generated by the application 320) and may transmit the uplink data 315 via at least a subset of the multiple PUSCH occasions included in the CG period 325. In some aspects, the UE 115 may transmit respective portions of a data packet via respective PUSCH occasions within the CG period 325 (such that a first portion of a data packet is transmitted via the PUSCH occasion 330-a, a second portion of the data packet is transmitted via the PUSCH occasion 330-b, and so on until the data packet is completely transmitted).

In some scenarios, and due in part to a random size of data generated at a time (e.g., supposing data generation periodicity is matched with CG periodicity), one or more PUSCH occasions configured in a CG period 325 may be unused for uplink data transmission. In other words, depending on an amount of data in an uplink buffer, some PUSCH occasions may be used while some PUSCH occasions may be skipped. As illustrated in the example of FIG. 3, the UE 115 may transmit an entirety of the uplink data 315 via the PUSCH occasion 330-a, the PUSCH occasion 330-b, and the PUSCH occasion 330-c and may accordingly refrain from using the PUSCH occasion 330-d (e.g., the UE 115 may skip the PUSCH occasion 330-d after the uplink data buffer is empty).

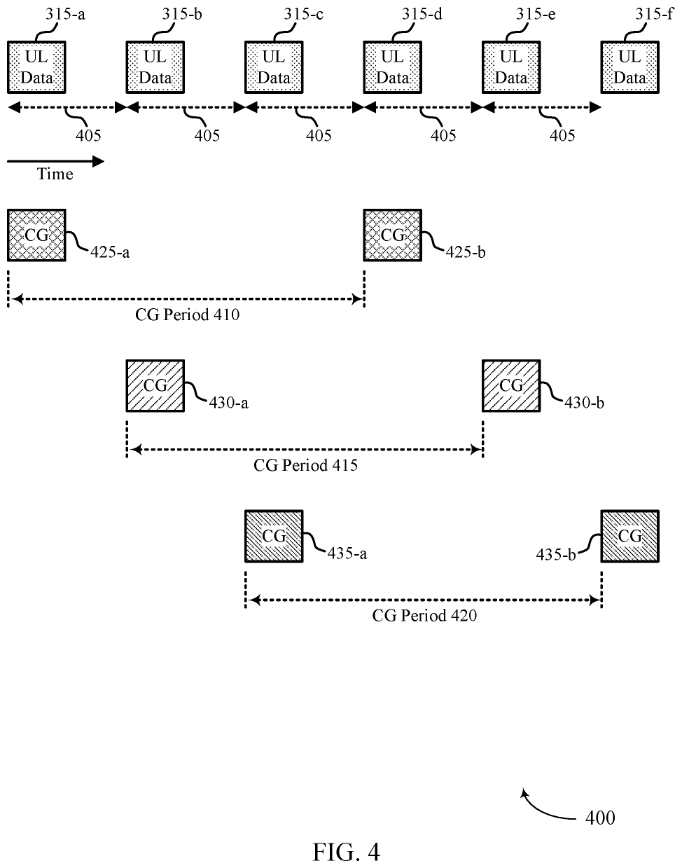

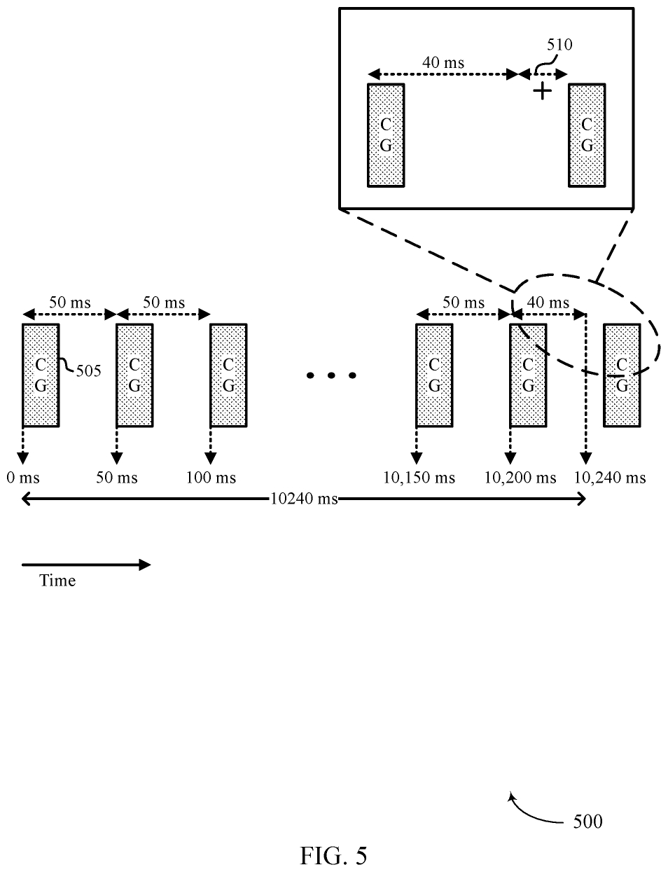

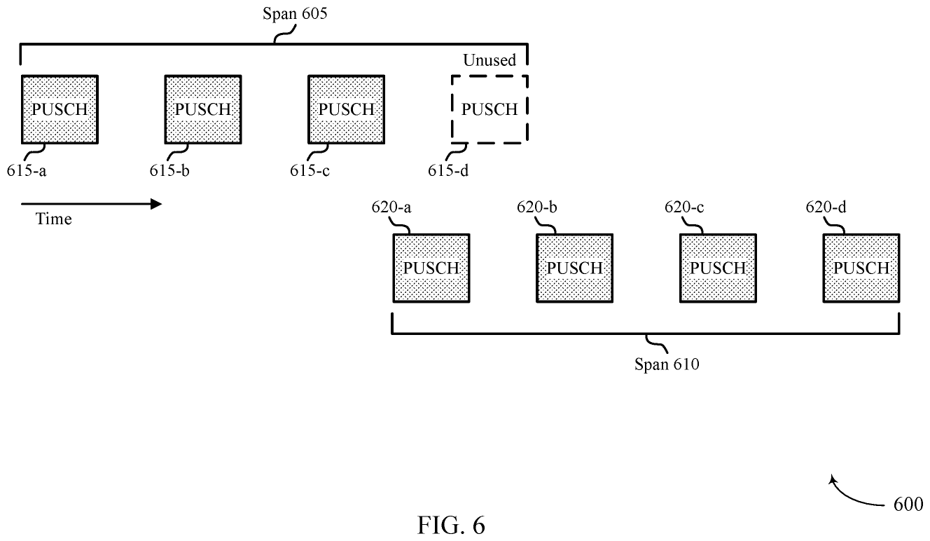

In some implementations, the UE 115 and the network entity 105 may support one or more signaling- or configuration-based mechanisms according to which the UE 115 and the network entity 105 may avoid glitches in latency-sensitive traffic and reduce ambiguity relating to scheduling and resource use expectations for PUSCH occasions within a multi-PUSCH occasion CG period across various deployment scenarios and use cases. For example, the UE 115 and the network entity 105 may support a configuration or activation of multiple uplink CG configurations simultaneously, where each of the multiple uplink CG configurations include or provide multiple PUSCH occasions per CG period, as illustrated by and described in more detail with reference to FIG. 4. Additionally, or alternatively, the UE 115 and the network entity 105 may support a calculation of a starting symbol index for a PUSCH occasion of a multi-PUSCH occasion CG configuration based on a periodicity of the multi-PUSCH occasion CG configuration, as illustrated by and described in more detail with reference to FIG. 5. Additionally, or alternatively, the UE 115 and the network entity 105 may support a rule according to which the UE 115 and the network entity 105 expect spans of PUSCH occasions within different CG periods to avoid overlapping in the time domain, as illustrated by and described in more detail with reference to FIG. 6.

FIG. 4 illustrates an example of a set of multi-PUSCH CG configurations 400 that support techniques for communicating uplink traffic via CG periods with multiple shared channel occasions in accordance with various aspects of the present disclosure. The set of multi-PUSCH CG configurations 400 may implement or be implemented to realize aspects of the present disclosure. For example, a network entity 105 may configure a UE 115 in accordance with the set of multi-PUSCH CG configurations 400 to adapt PUSCH occasion availability to a periodicity of data generation at the UE 115.

In some implementations, for instance, the UE 115 may activate or start an application 320 (as illustrated in FIG. 3) associated with uplink data 315 (as illustrated in FIG. 3) and the network entity 105 may align a CG periodicity with a periodicity of the generation of the uplink data 315 at the UE 115, where such a periodicity of data generation may be associated with a period 405. In an example, one application may be associated with using CG configurations with multiple PUSCH occasions per CG period to serve XR uplink transmission. In such an example, the periodicity of the data generation at the UE 115 may be associated with (e.g., equal to) a video frame periodicity, such as 60 frames per second (fps). As such, the network entity 105 may attempt to align a CG periodicity with the video frame periodicity.

In some systems, however, the UE 115 and the network entity 105 may support a finite set of options for a periodicity of an uplink CG configuration and the finite set of options may exclude a CG periodicity that is the same as or similar to a video frame periodicity. For example, 60 fps may correspond to a period of (1/60)×1000≅16.667 milliseconds, but the UE 115 and the network entity 105 may lack support for a CG period of approximately 16.667 milliseconds. Accordingly, in some implementations, the network entity 105 may configure or activate multiple multi-PUSCH occasion CG configurations with staggered offsets to flexibly adapt an effective CG period to a periodicity of data generation at the UE 115.

For example, in the example of FIG. 4, the network entity 105 may configure or activate a first uplink CG configuration (e.g., a first CG configuration) associated with a CG period 410, a second uplink CG configuration (e.g., a second CG configuration) associated with a CG period 415, and a third uplink CG configuration (e.g., a third CG configuration) associated with a CG period 420 and each of the first uplink CG configuration, the second uplink CG configuration, and the third uplink CG configuration may have staggered offsets. In the example of a video frame periodicity of 60 fps, which corresponds to a period of approximately 16.667 milliseconds, the network entity 105 may offset a starting position of the second uplink CG configuration from the first uplink CG configuration by approximately 16.667 milliseconds (e.g., 16 or 17 milliseconds) and may offset a starting position of the third uplink CG configuration from the first uplink CG configuration by approximately 33.334 milliseconds (e.g., 32, 33, or 34 milliseconds). In other words, the network entity 105 may set each of the CG period 410, the CG period 415, and the CG period 420 to 50 milliseconds and may stagger each of the uplink CG configurations by an offset of approximately (50/3)≅16.667 milliseconds (e.g., the network entity 105 may equally space three uplink CGs of CG period=50 milliseconds). As such, the CG period 410, the CG period 415, and the CG period 420 together may create an effective CG period of approximately 16.667 milliseconds.

Accordingly, the network entity 105 may provide available PUSCH occasions for the uplink data 315 at a periodicity associated with the periodicity of uplink data generation at the UE 115. For example, and as illustrated in FIG. 4, the UE 115 may transmit a data packet including uplink data 315-a via a CG occasion 425-a, a data packet including uplink data 315-b via a CG occasion 430-a, a data packet including uplink data 315-c via a CG occasion 435-a, a data packet including uplink data 315-d via a CG occasion 425-b, a data packet including uplink data 315-e via a CG occasion 430-b, and a data packet including uplink data 315-f via a CG occasion 435-b. In accordance with the present disclosure, each of the CG occasion 425-a, the CG occasion 425-b, the CG occasion 430-a, the CG occasion 430-b, the CG occasion 435-a, and the CG occasion 435-b may include one or multiple PUSCH occasions. As such, the UE 115 and the network entity may employ the set of multi-PUSCH CG configurations 400 to adapt to a rate of data generation at the UE 115 as well as to provide sufficient PUSCH occasions for relatively large size data packets.

Further, although shown in the context of three uplink CG configurations in the example of FIG. 4, the UE 115 and the network entity 105 may support any quantity of concurrent uplink CG configurations (e.g., four concurrent uplink CG configurations, five concurrent uplink CG configurations, etc.) to adapt to any rate of data generation at the UE 115. Additionally, in some implementations, the UE 115 and the network entity 105 may support capability signaling associated with support for multiple concurrent (e.g., concurrently activated) uplink CG configurations. Such a capability may apply to any type of concurrent uplink CG configurations or may be specific to concurrent uplink CG configurations having multiple PUSCH occasions per CG period.

Accordingly, in such implementations, the UE 115 may transmit an indication of the capability of the UE 115 to support multiple concurrent uplink CG configurations, where such an indication of the capability may indicate whether or not the UE 115 is capable of multiple concurrent uplink CG configurations or may indicate an upper limit quantity of concurrent uplink CG configurations the UE 115 is capable of supporting, or may indicate both. Additionally, or alternatively, the UE 115 may indicate or be associated with a capability to support a lower limit quantity of concurrent (e.g., concurrently activated) uplink CG configurations. For example, the UE 115 may be capable of supporting at least three concurrently activated uplink CG configurations. In some aspects, the network entity 105 may request the UE 115 to transmit an indication of the capability of the UE 115. In some other aspects, the UE 115 may transmit an indication of the capability of the UE 115 without solicitation from the network entity 105. In any of such aspects, the network entity 105 may configure or activate one or more uplink CG configurations at the UE 115 in accordance with the capability of the UE 115.

FIG. 5 illustrates an example of a communication timeline 500 that supports techniques for communicating uplink traffic via CG periods with multiple shared channel occasions in accordance with various aspects of the present disclosure. The communication timeline 500 may implement or be implemented to realize aspects of the present disclosure. For example, a UE 115 and a network entity 105 may communicate uplink data 315 (as illustrated in FIG. 3) via CG periods 505 (which may each include one or multiple PUSCH occasions and may be equivalently referred to as CG occasions) and may employ techniques to calculate a starting symbol for a CG period 505 (e.g., a starting symbol of a first PUSCH occasion of a CG period 505) based on a duration of the CG period 505.

In some systems, an N^{th} period of a CG configuration may start at a symbol when the symbol index is within a time duration corresponding to a value range of SFN=(starting symbol+N×periodicity) MOD ((maximum SFN value+1)×SlotsPerFrame×SymbolsPerSlot). The network entity 105 may indicate the ‘starting symbol’ value via control signaling (e.g., via RRC configuration) for Type 1 CG configuration or via activation DCI for Type 2 CG configuration. The ‘periodicity’ value may correspond to the periodicity of the CG configuration. As illustrated in FIG. 5, an initial starting symbol may be 0 for purpose of example.

For some periodicities, however, CG periods calculated, determined, identified, or otherwise selected in accordance with the SFN equation may not be equally spaced. For example, for a periodicity of 50 milliseconds, an unequal spacing between the starts of CG periods 505 (and likewise a glitch in data transmission) may occur when SFN wraps around from a maximum value to a minimum value (e.g., when SFN resets from 1023 to 0) because an entire time duration over the range of SFN values (e.g., 1024 values, corresponding to 10,240 milliseconds) may not be an integer multiple of 50 milliseconds. As such, and because a CG period is automatically placed each time SFN=0 (e.g., each time SFN resets from a maximum value to a minimum value), in every 10,240 milliseconds, there may be an additional misalignment of approximately 10 milliseconds between the CG periods 505 and the periodic data generation at the UE 115.

Accordingly, in some implementations, the UE 115 and the network entity 105 employ a starting symbol index calculation that is specifically based on a duration of a corresponding CG period when calculating starting symbol indexes for CG periods 505 such that the starting symbol index calculation may result in equally spaced CG periods in the time domain. In some examples, the UE 115 and the network entity 105 may define and support a system frame number SFN_M in a dedicated range of SFN values (e.g., 0 to 999) to calculate, determine, identify, or otherwise select the CG period, where a formula for calculating a starting symbol may replace ‘SFN’ and ‘maximum SFN value’ with ‘SFN_M’ and ‘maximum SFN_M value,’ respectively. The UE 115 or the network entity 105, or both, may set or configure the dedicated range of SFN values as a multiple of a duration of a CG period such that the duration of the CG period divides evenly into a maximum SFN_M value. By setting or configuring the dedicated range of SFN values as a multiple of a duration of a CG period, the UE 115 and the network entity 105 may avoid misalignment between CG periods and periodic data generation caused by SFN resetting from a maximum value to a minimum value.

In some other examples, the UE 115 and the network entity 105 may support a mechanism according to which the UE 115 and the network entity 105 adjust a ‘starting symbol’ for a CG period when SFN wraps around (e.g., when an SFN value resets from a maximum value to a minimum value). In such examples, for instance, the UE 115 and the network entity 105 may increase or decrease a starting symbol by a dedicated value 510 each time the SFN resets from a maximum value to a minimum value (e.g., switches from 1023 to 0). The UE 115 and the network entity 105 may set or configure the dedicated value 510 based on a modulo operation of the maximum SFN value by a duration of a CG period. For example, a modulo operation of 10,240 milliseconds (e.g., an amount of time representative of a maximum value 1023 of the SFN) by 50 milliseconds (an example CG period duration) results in 40 milliseconds. As such, each time SFN resets from the maximum value to the minimum value, the UE 115 and the network entity 105 may increase (e.g., increment) the ‘starting symbol’ by 10 milliseconds (such that the dedicated value=10 milliseconds) or may decrease (e.g., decrement) the ‘starting symbol’ by 40 milliseconds (such that the dedicated value=40 milliseconds) to avoid misalignment between CG periods and periodic data generation caused by SFN resetting from a maximum value to a minimum value. In other words, in the example of a CG period duration of 50 milliseconds, the UE 115 and the network entity 105 may increment by 10 milliseconds and MOD by 50 milliseconds.

FIG. 6 illustrates an example of a communication timeline 600 that supports techniques for communicating uplink traffic via CG periods with multiple shared channel occasions in accordance with various aspects of the present disclosure. The communication timeline 600 may implement or be implemented to realize aspects of the present disclosure. For example, a UE 115 and a network entity 105 may support one or more uplink CG configurations associated with a first set of PUSCH occasions 615 within a first CG period and a second set of PUSCH occasions 620 within a second CG period and may employ a rule according to which the UE 115 and the network entity 105 handle uplink data communication if a first span 605 of the first set of PUSCH occasions 615 overlaps in time with a second span 610 of the second set of PUSCH occasions 620. The first set of PUSCH occasions 615 and the second set of PUSCH occasions 620 may be associated with a same uplink CG configuration or different uplink CG configurations.

In some aspects, the UE 115 and the network entity 105 may expect that a CG period of multiple PUSCH occasions is meant to provide sufficient resources to transmit an entire data packet generated within a CG periodicity. As such, in some aspects, the UE 115 and the network entity 105 may expect all PUSCH occasions to be confined within an earlier CG period before a subsequent CG period starts (as the UE 115 and the network entity 105 may expect that the network entity 105 would have otherwise allocated more bandwidth or denser PUSCH occasions within the earlier CG period).

Accordingly, in some implementations, the UE 115 and the network entity 105 may also support a time domain overlapping rule associated with spans of PUSCH occasions, where such a rule may be indicative of an expectation that spans of PUSCHs of two CG periods are unable (e.g., not allowed or not expected) to overlap in the time domain. Additionally, or alternatively, the UE 115 and the network entity 105 may support a rule according to which the UE 115 and the network entity handle, in a mutually understood manner, PUSCH occasions when spans of PUSCHs of different CG periods do overlap.

As described herein, a span may be defined as a time duration from the start of a first PUSCH to an end of a last PUSCH in a given CG period. In some aspects, if repetition is enabled for one or multiple PUSCHs of a CG period, a span may be defined based on all repetitions of the PUSCHs of the same CG period. For example, the first set of PUSCH occasions 615 may include a PUSCH occasion 615-a, a PUSCH occasion 615-b, a PUSCH occasion 615-c, and a PUSCH occasion 615-d and the first span 605 may be a time duration from a starting point of the PUSCH occasion 615-a to an ending point of the PUSCH occasion 615-d. For further example, the second set of PUSCH occasions 620 may include a PUSCH occasion 620-a, a PUSCH occasion 620-b, a PUSCH occasion 620-c, and a PUSCH occasion 620-d and the second span 610 may be a time duration from a starting point of the PUSCH occasion 620-a to an ending point of the PUSCH occasion 620-d.

In some implementations, for example, the network entity 105 may schedule, configure, or activate one or more uplink CG configurations with overlapping spans of PUSCHs of different CG periods to re-purpose a PUSCH occasion of one span that overlaps with another span for another use. For example, the network entity 105 may re-allocate such a PUSCH occasion to another device different from the UE 115 or to another use. Accordingly, the UE 115 may skip (e.g., refrain from transmitting via) such a PUSCH occasion. In some aspects, the network entity 105 may leverage an expected skipping of PUSCH occasions by the UE 115 and intentionally schedule, configure, or activate one or more uplink CG configurations with overlapping spans of PUSCHs to reserve resources for a higher priority data traffic or to accommodate multiple traffics (where the UE 115 provides a first traffic and a second device uses occasions skipped by the UE 115 to provide a second traffic).

In some implementations, the UE 115 may refrain from transmitting via a PUSCH on a PUSCH occasion of a CG period if the PUSCH overlaps with a span of PUSCHs of a subsequent CG period. For example, and as illustrated in the example of FIG. 6, because the PUSCH occasion 615-d of the first span 605 overlaps with the second span 610 of a subsequent CG period, the UE 115 may refrain from transmitting via the PUSCH of the PUSCH occasion 615-d (but may transmit via the PUSCH of the PUSCH occasion 620-a). The network entity 105 may re-allocate the PUSCH of the PUSCH occasion 615-d to another device or another use. In some other implementations, the UE 115 may refrain from transmitting via a PUSCH on a PUSCH occasion of a CG period if the PUSCH overlaps with a span of PUSCHs of an earlier CG period. For example, because the PUSCH occasion 620-a of the second span 610 overlaps with the first span 605 of an earlier CG period, the UE 115 may refrain from transmitting via the PUSCH of the PUSCH occasion 620-a (but may transmit via the PUSCH of the PUSCH occasion 615-d). The network entity 105 may re-allocate the PUSCH of the PUSCH occasion 620-a to another device or another use.

In some aspects, a PUSCH in the rule may be a PUSCH occasion or a PUSCH occasion where PUSCH would have otherwise been transmitted. Further, in some aspects, such a rule may apply universally at the UE 115 and the network entity 105 or may apply on a per-TRP basis. For example, the UE 115 and the network entity may apply such a rule for any overlapping spans of PUSCHs associated with a first TRP and may separately apply such a rule for any overlapping spans of PUSCHs associated with a second TRP, while refraining from applying such a rule between a first span of PUSCHs associated with the first TRP and a second span of PUSCHs associated with the second TRP. In other words, the UE 115 and the network entity 105 may refrain from applying the rule to overlapping spans of PUSCHs of different CG periods that are associated with different TRPs. In some aspects, the UE 115 and the network entity 105 may apply such a rule to a CG period that includes a single PUSCH occasion. In such aspects, the rule may be indicative of an expectation that PUSCHs of two CG periods avoid overlapping in the time domain.

Such rules and mechanisms (e.g., the time domain overlapping rule or any other expectation mutually understood between the UE 115 and the network entity 105) may be signaled (e.g., via RRC signaling) between the UE 115 and the network entity 105 or may be pre-loaded at one or both of the UE 115 or the network entity 105, or any combination thereof. In some aspects, for example, the rules and mechanisms may be defined in a network specification and identified (e.g., referenced) by the UE 115 and the network entity 105 when the network entity 105 configures or activates one or more uplink CG configurations or when the UE 115 transmits uplink data packets via PUSCH occasions of one or more uplink CG configurations, or both.

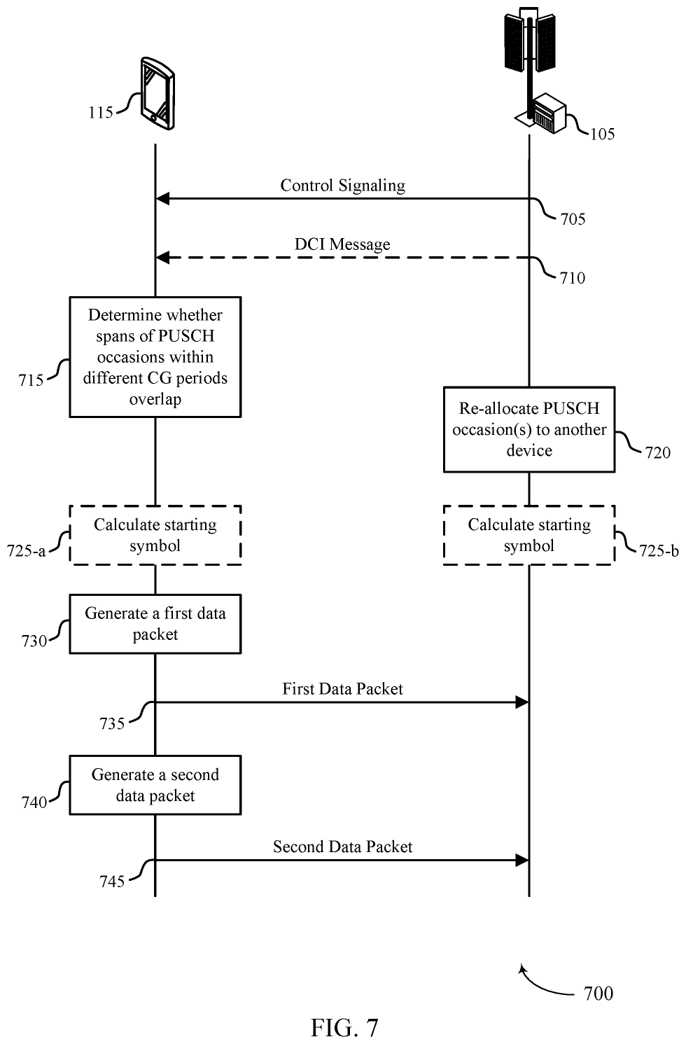

FIG. 7 illustrates an example of a process flow 700 that supports techniques for communicating uplink traffic via CG periods with multiple shared channel occasions in accordance with various aspects of the present disclosure. The process flow 700 may implement or be implemented to realize aspects of the present disclosure. For example, the process flow 700 illustrates communication between a UE 115 and the network entity 105, which may be examples of corresponding devices illustrated by and described with reference to any one or more of FIGS. 1-6. In some implementations, the UE 115 and the network entity 105 may support one or more signaling- or configuration-based mechanisms according to which the UE 115 and the network entity 105 may avoid glitches in latency-sensitive traffic and reduce ambiguity relating to scheduling and resource use expectations for PUSCH occasions within a multi-PUSCH occasion CG period across various deployment scenarios and use cases.

In the following description of the process flow 700, the operations may be performed (such as reported or provided) in a different order than the order shown, or the operations performed by the example devices may be performed in different orders or at different times. Some operations also may be left out of the process flow 700, or other operations may be added to the process flow 700. Further, although some operations or signaling may be shown to occur at different times for discussion purposes, these operations may actually occur at the same time.

At 705, the UE 115 may receive, from the network entity 105, control signaling associated with one or more uplink CGs usable by the UE. In some examples, the one or more uplink CGs may include a first set of uplink shared channel transmission occasions (e.g., a first set of PUSCH occasions) within a first CG period and a second set of uplink shared channel transmission occasions (e.g., a second set of PUSCH occasions) within a second CG period.

In some aspects, the control signaling may include information indicative of a first time domain resource allocation associated with the first set of PUSCH occasions and a second time domain resource allocation associated with the second set of PUSCH occasions. In such aspects, the UE 115 may identify a time duration of a first span of the first set of PUSCH occasions and a time duration of a second span of the second set of PUSCH occasions based on the first and second time domain resource allocations. The first span may include a time duration between a starting point of an initial PUSCH occasion of the first set of PUSCH occasions and an ending point of a final PUSCH occasion of the first set of uplink PUSCH occasions. Similarly, the second span may include a time duration between a starting point of an initial PUSCH occasion of the second set of PUSCH occasions and an ending point of a final PUSCH occasion of the second set of uplink PUSCH occasions.

In some aspects, the UE 115 may receive, via the control signaling, information associated with the one or more uplink CGs in accordance with a time domain overlapping rule. In such aspects, the time domain overlapping rule may be indicative of an expectation that spans of sets of PUSCH occasions within different CG periods avoid overlapping in time. In other words, the first and second spans of the first and second sets of PUSCH occasions, respectively, are not expected to overlap (e.g., are prohibited from overlapping) in time in accordance with (e.g., in agreement or in line with) the time domain overlapping rule. In some examples, the UE 115 may apply the time domain overlapping rule on a per-TRP basis.

At 710, the UE 115 may, in some implementations, receive a DCI message from the network entity 105 associated with one or more uplink CGs. For example, the UE 115 may receive an activation DCI activating one or more uplink CGs for use by the UE 115.

At 715, the UE 115 may determine, identify, or otherwise ascertain whether spans of sets of PUSCH occasions within different CG periods overlap in time. For example, the UE 115 may determine whether the first span of the first set of PUSCH occasions overlaps in time with the second span of the second set of PUSCH occasions.

At 720, the network entity 105 may, if the first span of the first set of PUSCH occasions overlaps in time with the second span of the second set of PUSCH occasions, re-allocate one or more PUSCH occasions to another device or to another use. In some implementations, the network entity may re-allocate the one or more PUSCH occasions from a relatively earlier span of PUSCH occasions or from a relatively later span of PUSCH occasions in accordance with a rule specifying how PUSCH occasions of a span that overlaps with another span of PUSCH occasions are to be used.

At 725-a and 725-b, the UE 115 and the network entity 105 may calculate a starting symbol for a PUSCH occasion of a set of PUSCH occasions (e.g., a PUSCH occasion of the first set of PUSCH occasions or a PUSCH occasion of the second set of PUSCH occasions). The UE 115 and the network entity 105 may calculate the starting symbol based on a duration of a CG period (e.g., a duration of the first CG period or a duration of the second CG period), as illustrated by and described in more detail with reference to FIG. 5.

At 730, the UE 115 may generate a first data packet based on an application of the UE 115 and, at 735, the UE 115 may transmit the first data packet via at least a subset of the first set of PUSCH occasions within the first CG period. In some examples, the UE 115 may transmit respective portions of the first data packet via respective PUSCH occasions of the first set of PUSCH occasions (until the first data packet is completely transmitted).

At 740, the UE 115 may generate a second data packet based on the application of the UE 115 and, at 745, the UE 115 may transmit the second data packet via at least a subset of the second set of PUSCH occasions within the second CG period. In some examples, the UE 115 may transmit respective portions of the second data packet via respective PUSCH occasions of the second set of PUSCH occasions (until the second data packet is completely transmitted).

In some implementations, such as in implementations in which the first set of PUSCH occasions are associated with a first uplink CG and the second set of PUSCH occasions are associated with a second uplink CG different from the first uplink CG, the network entity 105 may apply staggered offsets between the first CG period and the second CG period to create an effective CG period that is shorter than each of the first CG period and the second CG period alone. In such implementations, the network entity 105 may set or configure the effective CG period based on a periodicity of data generation at the UE 115, which may in turn be based on the specific type of application performed by the UE 115 (of which the UE 115 may inform the network entity 105 via signaling or messaging). As such, the UE 115 may generate the first data packet and the second date packet in accordance with (e.g., in alignment with) the effective CG period.

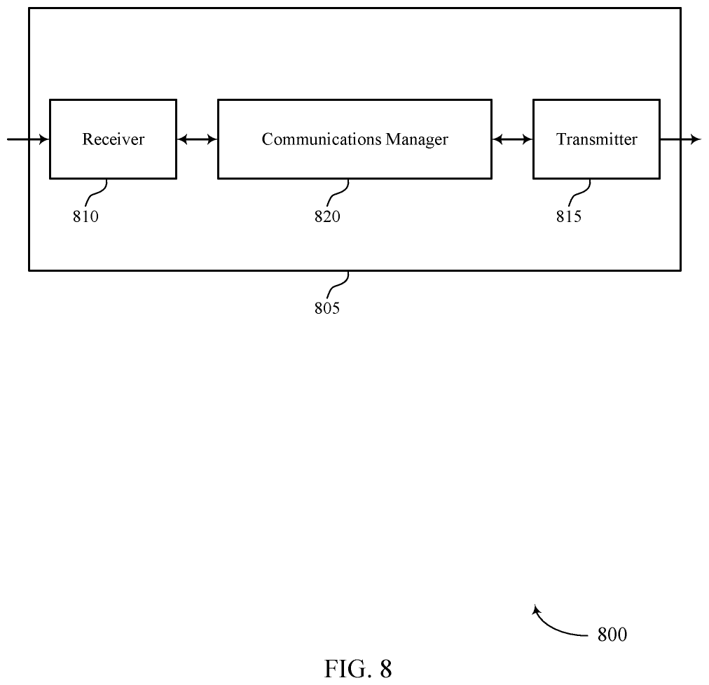

FIG. 8 illustrates a block diagram 800 of a device 805 that supports techniques for communicating uplink traffic via CG periods with multiple shared channel occasions in accordance with various aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for communicating uplink traffic via CG periods with multiple shared channel occasions). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for communicating uplink traffic via CG periods with multiple shared channel occasions). In some examples, the transmitter 815 may be co-located with a receiver 810 in a transceiver component. The transmitter 815 may utilize a single antenna or a set of multiple antennas.

The communications manager 820, the receiver 810, the transmitter 815, or various combinations thereof or various components thereof may be examples of means for performing various aspects of techniques for communicating uplink traffic via CG periods with multiple shared channel occasions as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 may be configured as or otherwise support a means for receiving control signaling associated with one or more uplink CGs usable by the UE, the one or more uplink CGs including a first set of uplink shared channel transmission occasions within a first CG period and a second set of uplink shared channel transmission occasions within a second CG period. The communications manager 820 may be configured as or otherwise support a means for transmitting, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, and more efficient utilization of communication resources.

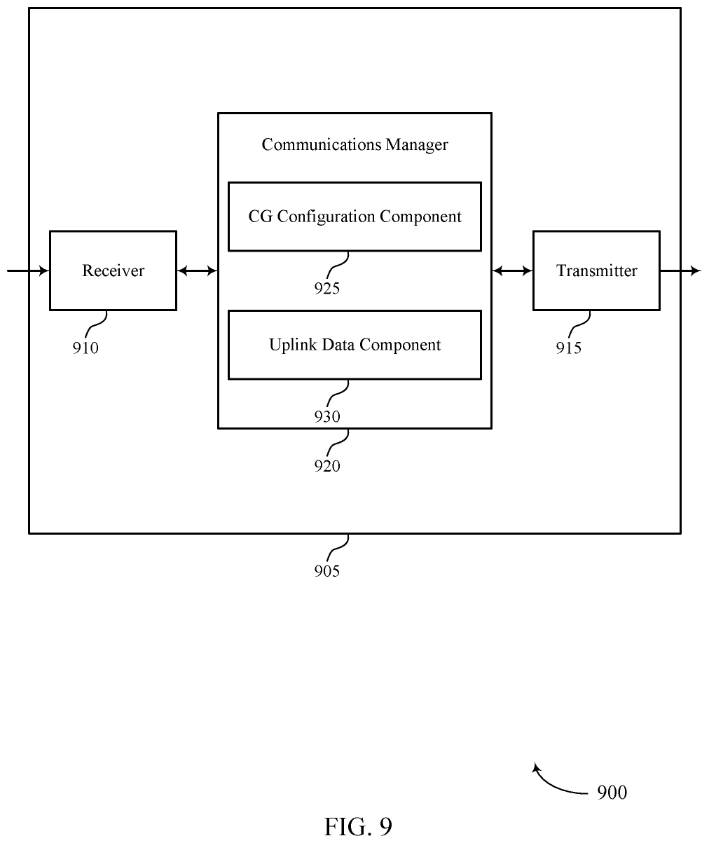

FIG. 9 illustrates a block diagram 900 of a device 905 that supports techniques for communicating uplink traffic via CG periods with multiple shared channel occasions in accordance with various aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for communicating uplink traffic via CG periods with multiple shared channel occasions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for communicating uplink traffic via CG periods with multiple shared channel occasions). In some examples, the transmitter 915 may be co-located with a receiver 910 in a transceiver component. The transmitter 915 may utilize a single antenna or a set of multiple antennas.

The device 905, or various components thereof, may be an example of means for performing various aspects of techniques for communicating uplink traffic via CG periods with multiple shared channel occasions as described herein. For example, the communications manager 920 may include a CG configuration component 925 an uplink data component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The CG configuration component 925 may be configured as or otherwise support a means for receiving control signaling associated with one or more uplink CGs usable by the UE, the one or more uplink CGs including a first set of uplink shared channel transmission occasions within a first CG period and a second set of uplink shared channel transmission occasions within a second CG period. The uplink data component 930 may be configured as or otherwise support a means for transmitting, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

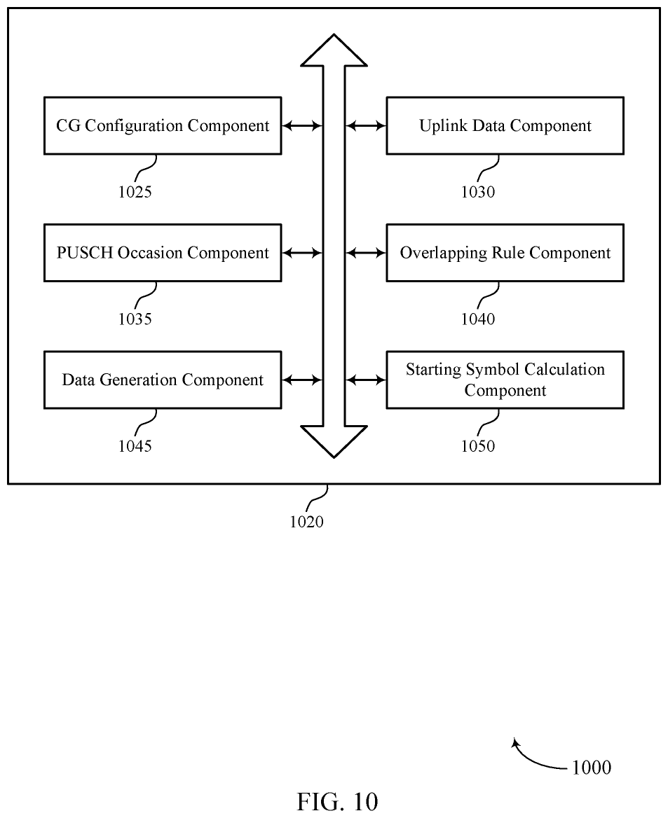

FIG. 10 illustrates a block diagram 1000 of a communications manager 1020 that supports techniques for communicating uplink traffic via CG periods with multiple shared channel occasions in accordance with various aspects of the present disclosure. The communications manager 1020 may be an example of aspects of a communications manager 820, a communications manager 920, or both, as described herein. The communications manager 1020, or various components thereof, may be an example of means for performing various aspects of techniques for communicating uplink traffic via CG periods with multiple shared channel occasions as described herein. For example, the communications manager 1020 may include a CG configuration component 1025, an uplink data component 1030, an PUSCH occasion component 1035, an overlapping rule component 1040, a data generation component 1045, a starting symbol calculation component 1050, or any combination thereof. Each of these components may communicate, directly or indirectly, with one another (e.g., via one or more buses).

The communications manager 1020 may support wireless communication at a UE in accordance with examples as disclosed herein. The CG configuration component 1025 may be configured as or otherwise support a means for receiving control signaling associated with one or more uplink CGs usable by the UE, the one or more uplink CGs including a first set of uplink shared channel transmission occasions within a first CG period and a second set of uplink shared channel transmission occasions within a second CG period. The uplink data component 1030 may be configured as or otherwise support a means for transmitting, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

In some examples, the CG configuration component 1025 may be configured as or otherwise support a means for receiving, via the control signaling, an indication of a first time domain resource allocation associated with the first set of uplink shared channel transmission occasions and a second time domain resource allocation associated with the second set of uplink shared channel transmission occasions, where the first span is associated with the first time domain resource allocation and the second span is associated with the second time domain resource allocation. In some examples, the PUSCH occasion component 1035 may be configured as or otherwise support a means for skipping an uplink shared channel transmission occasion of the first set of uplink shared channel transmission occasions in accordance with the uplink shared channel transmission occasion overlapping in time with the second span of the second set of uplink shared channel transmission occasions.

In some examples, to support skipping the uplink shared channel transmission occasion of the first set of uplink shared channel transmission occasions, the PUSCH occasion component 1035 may be configured as or otherwise support a means for skipping the uplink shared channel transmission occasion of the first set of uplink shared channel transmission occasions in accordance with the first span of the first set of uplink shared channel transmission occasions being associated with an earlier start time than the second span of the second set of uplink shared channel transmission occasions.

In some examples, to support skipping the uplink shared channel transmission occasion of the first set of uplink shared channel transmission occasions, the PUSCH occasion component 1035 may be configured as or otherwise support a means for skipping the uplink shared channel transmission occasion of the first set of uplink shared channel transmission occasions in accordance with the first span of the first set of uplink shared channel transmission occasions being associated with a later start time than the second span of the second set of uplink shared channel transmission occasions.

In some examples, to support receiving the control signaling, the overlapping rule component 1040 may be configured as or otherwise support a means for receiving information associated with the one or more uplink CGs in accordance with a time domain overlapping rule, where the time domain overlapping rule is indicative of an expectation that spans of sets of uplink shared channel transmission occasions within different CG periods avoid overlapping in time.

In some examples, the time domain overlapping rule is applied on a per-TRP basis.

In some examples, the first span is a time duration between a starting point of an initial uplink shared channel transmission occasion of the first set of uplink shared channel transmission occasions and an ending point of a final uplink shared channel transmission occasion of the first set of uplink shared channel transmission occasions, and the second span is a time duration between a starting point of an initial uplink shared channel transmission occasion of the second set of uplink shared channel transmission occasions and an ending point of a final uplink shared channel transmission occasion of the second set of uplink shared channel transmission occasions. In some examples, the first set of uplink shared channel transmission occasions is periodically available to the UE in accordance with the first CG period and the second set of uplink shared channel transmission occasions is periodically available to the UE in accordance with the second CG period.

In some examples, the first span and the second span are associated with a same CG.

In some examples, the first span and the second span are associated with different CGs.

In some examples, the first span includes all repetitions of uplink shared channel transmission occasions within the first CG period and the second span includes all repetitions of uplink shared channel transmission occasions within the second CG period.

In some examples, the CG configuration component 1025 may be configured as or otherwise support a means for receiving, via the control signaling, an indication that the first set of uplink shared channel transmission occasions is associated with a first CG and the second set of uplink shared channel transmission occasions is associated with a second CG, where the first CG period and the second CG period partially overlap to create an effective CG period shorter than each of the first CG period and the second CG period. In some examples, the data generation component 1045 may be configured as or otherwise support a means for generating the first data packet and the second data packet in accordance with the effective CG period. In some examples, the uplink data component 1030 may be configured as or otherwise support a means for transmitting the first data packet via the first set of uplink shared channel transmission occasions and the second data packet via the second set of uplink shared channel transmission occasions in accordance with the effective CG period.

In some examples, to support transmitting the first data packet and the second data packet, the uplink data component 1030 may be configured as or otherwise support a means for transmitting respective portions of the first data packet via respective uplink shared channel transmission occasions of the first set of uplink shared channel transmission occasions. In some examples, to support transmitting the first data packet and the second data packet, the uplink data component 1030 may be configured as or otherwise support a means for transmitting respective portions of the second data packet via respective uplink shared channel transmission occasions of the second set of uplink shared channel transmission occasions.

In some examples, the starting symbol calculation component 1050 may be configured as or otherwise support a means for calculating a starting symbol associated with an uplink shared channel occasion of the first set of uplink shared channel transmission occasions or the second set of uplink shared channel transmission occasions in accordance with a dedicated range of SFN values, where the dedicated range of SFN values is a multiple of a duration of the first CG period or the second CG period, respectively.

In some examples, the starting symbol calculation component 1050 may be configured as or otherwise support a means for calculating a starting symbol associated with an uplink shared channel occasion of the first set of uplink shared channel transmission occasions or the second set of uplink shared channel transmission occasions in accordance with increasing or decreasing the starting symbol by a dedicated value each time an SFN resets from a maximum value to a minimum value, where the dedicated value is based on a modulo operation of the maximum value by a duration of the first CG period or the second CG period.

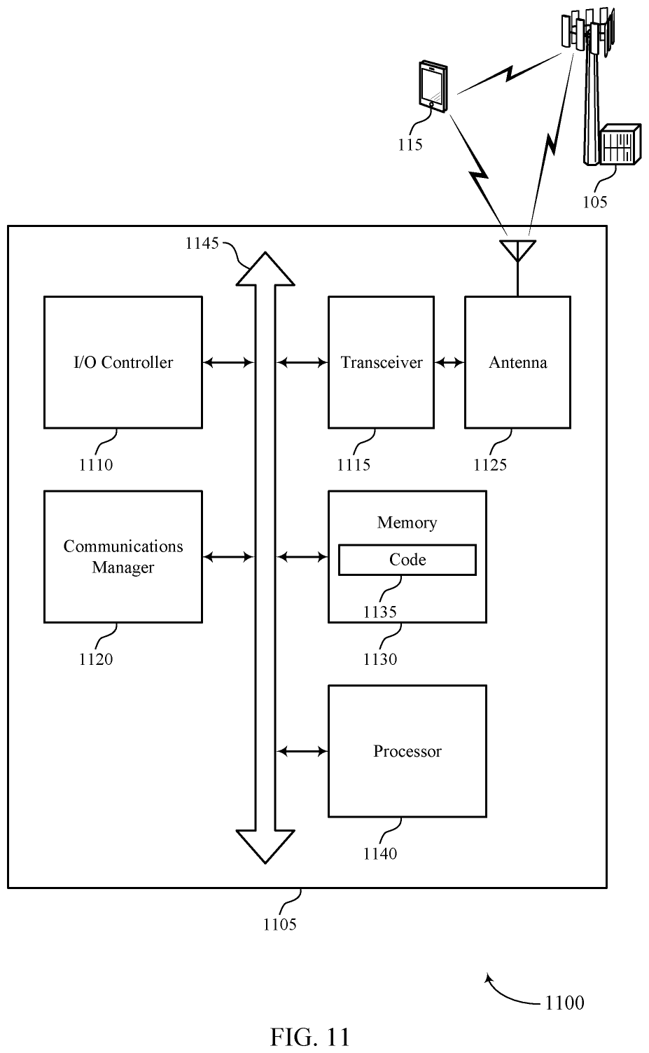

FIG. 11 illustrates a diagram of a system 1100 including a device 1105 that supports techniques for communicating uplink traffic via CG periods with multiple shared channel occasions in accordance with various aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for communicating uplink traffic via CG periods with multiple shared channel occasions). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving control signaling associated with one or more uplink CGs usable by the UE, the one or more uplink CGs including a first set of uplink shared channel transmission occasions within a first CG period and a second set of uplink shared channel transmission occasions within a second CG period. The communications manager 1120 may be configured as or otherwise support a means for transmitting, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for communicating uplink traffic via CG periods with multiple shared channel occasions as described herein, or the processor 1140 and the memory 1130 may be otherwise configured to perform or support such operations.

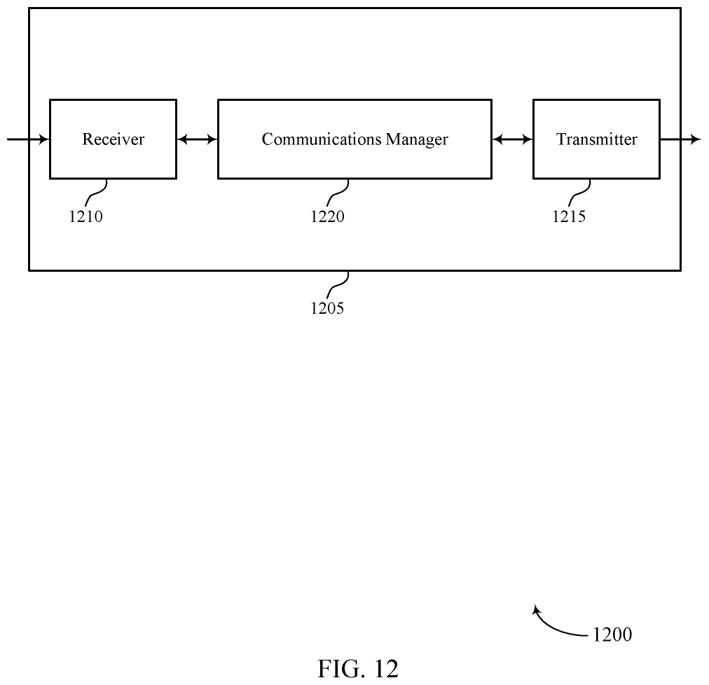

FIG. 12 illustrates a block diagram 1200 of a device 1205 that supports techniques for communicating uplink traffic via CG periods with multiple shared channel occasions in accordance with various aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of techniques for communicating uplink traffic via CG periods with multiple shared channel occasions as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 may be configured as or otherwise support a means for transmitting control signaling associated with one or more uplink CGs usable by a UE, the one or more uplink CGs including a first set of uplink shared channel transmission occasions within a first CG period and a second set of uplink shared channel transmission occasions within a second CG period. The communications manager 1220 may be configured as or otherwise support a means for receiving, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for reduced processing, reduced power consumption, and more efficient utilization of communication resources.

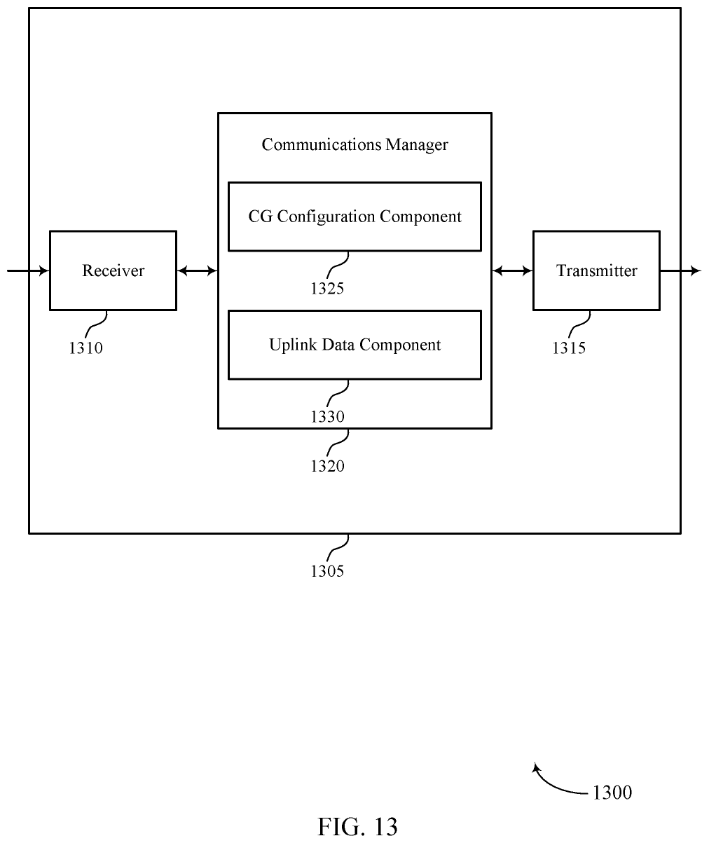

FIG. 13 illustrates a block diagram 1300 of a device 1305 that supports techniques for communicating uplink traffic via CG periods with multiple shared channel occasions in accordance with various aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for communicating uplink traffic via CG periods with multiple shared channel occasions as described herein. For example, the communications manager 1320 may include a CG configuration component 1325 an uplink data component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The CG configuration component 1325 may be configured as or otherwise support a means for transmitting control signaling associated with one or more uplink CGs usable by a UE, the one or more uplink CGs including a first set of uplink shared channel transmission occasions within a first CG period and a second set of uplink shared channel transmission occasions within a second CG period. The uplink data component 1330 may be configured as or otherwise support a means for receiving, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

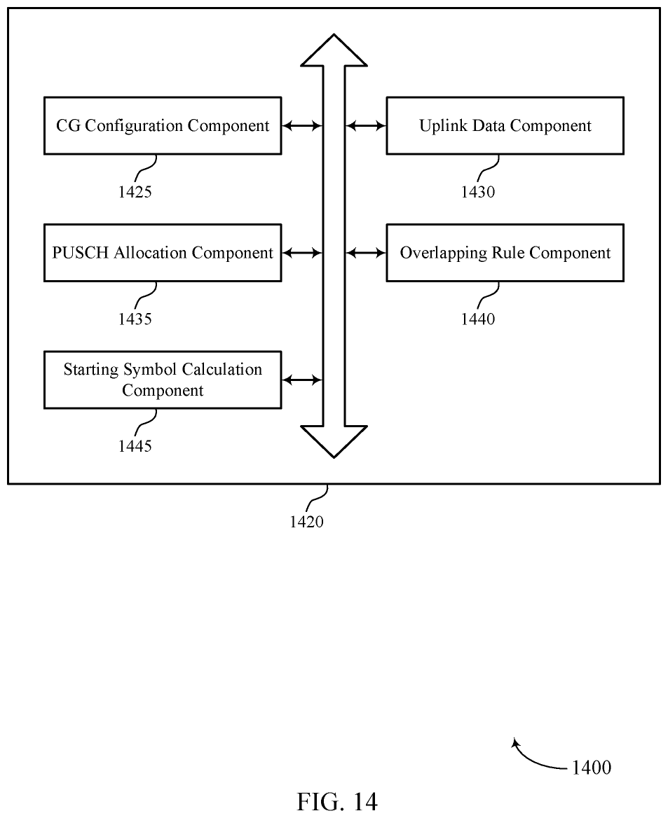

FIG. 14 illustrates a block diagram 1400 of a communications manager 1420 that supports techniques for communicating uplink traffic via CG periods with multiple shared channel occasions in accordance with various aspects of the present disclosure. The communications manager 1420 may be an example of aspects of a communications manager 1220, a communications manager 1320, or both, as described herein. The communications manager 1420, or various components thereof, may be an example of means for performing various aspects of techniques for communicating uplink traffic via CG periods with multiple shared channel occasions as described herein. For example, the communications manager 1420 may include a CG configuration component 1425, an uplink data component 1430, an PUSCH allocation component 1435, an overlapping rule component 1440, a starting symbol calculation component 1445, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The CG configuration component 1425 may be configured as or otherwise support a means for transmitting control signaling associated with one or more uplink CGs usable by a UE, the one or more uplink CGs including a first set of uplink shared channel transmission occasions within a first CG period and a second set of uplink shared channel transmission occasions within a second CG period. The uplink data component 1430 may be configured as or otherwise support a means for receiving, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

In some examples, the CG configuration component 1425 may be configured as or otherwise support a means for transmitting, via the control signaling, an indication of a first time domain resource allocation associated with the first set of uplink shared channel transmission occasions and a second time domain resource allocation associated with the second set of uplink shared channel transmission occasions, where the first span is associated with the first time domain resource allocation and the second span is associated with the second time domain resource allocation. In some examples, the PUSCH allocation component 1435 may be configured as or otherwise support a means for allocating, to a device different from the UE, an uplink shared channel transmission occasion of the first set of uplink shared channel transmission occasions in accordance with the uplink shared channel transmission occasion overlapping in time with the second span of the second set of uplink shared channel transmission occasions.

In some examples, to support allocating the uplink shared channel transmission occasion of the first set of uplink shared channel transmission occasions to the device different from the UE, the PUSCH allocation component 1435 may be configured as or otherwise support a means for allocating the uplink shared channel transmission occasion of the first set of uplink shared channel transmission occasions in accordance with the first span of the first set of uplink shared channel transmission occasions being associated with an earlier start time than the second span of the second set of uplink shared channel transmission occasions.

In some examples, to support allocating the uplink shared channel transmission occasion of the first set of uplink shared channel transmission occasions to the device different from the UE, the PUSCH allocation component 1435 may be configured as or otherwise support a means for allocating the uplink shared channel transmission occasion of the first set of uplink shared channel transmission occasions in accordance with the first span of the first set of uplink shared channel transmission occasions being associated with a later start time than the second span of the second set of uplink shared channel transmission occasions.

In some examples, to support transmitting the control signaling, the overlapping rule component 1440 may be configured as or otherwise support a means for transmitting information associated with the one or more uplink CGs in accordance with a time domain overlapping rule, where the time domain overlapping rule is indicative of an expectation that spans of sets of uplink shared channel transmission occasions within different CG periods avoid overlapping in time.

In some examples, the time domain overlapping rule is applied on a per-TRP basis.

In some examples, the first span is a time duration between a starting point of an initial uplink shared channel transmission occasion of the first set of uplink shared channel transmission occasions and an ending point of a final uplink shared channel transmission occasion of the first set of uplink shared channel transmission occasions, and the second span is a time duration between a starting point of an initial uplink shared channel transmission occasion of the second set of uplink shared channel transmission occasions and an ending point of a final uplink shared channel transmission occasion of the second set of uplink shared channel transmission occasions. In some examples, the first set of uplink shared channel transmission occasions is periodically available to the UE in accordance with the first CG period and the second set of uplink shared channel transmission occasions is periodically available to the UE in accordance with the second CG period.

In some examples, the first span and the second span are associated with a same CG.

In some examples, the first span and the second span are associated with different CGs.

In some examples, the first span includes all repetitions of uplink shared channel transmission occasions within the first CG period and the second span includes all repetitions of uplink shared channel transmission occasions within the second CG period.

In some examples, the CG configuration component 1425 may be configured as or otherwise support a means for transmitting, via the control signaling, an indication that the first set of uplink shared channel transmission occasions is associated with a first CG and the second set of uplink shared channel transmission occasions is associated with a second CG, where the first CG period and the second CG period partially overlap to create an effective CG period shorter than each of the first CG period and the second CG period, and where a duration of the effective CG period is based on a data generation frequency at the UE. In some examples, the uplink data component 1430 may be configured as or otherwise support a means for receiving the first data packet via the first set of uplink shared channel transmission occasions and the second data packet via the second set of uplink shared channel transmission occasions in accordance with the effective CG period.

In some examples, to support receiving the first data packet and the second data packet, the uplink data component 1430 may be configured as or otherwise support a means for receiving respective portions of the first data packet via respective uplink shared channel transmission occasions of the first set of uplink shared channel transmission occasions. In some examples, to support receiving the first data packet and the second data packet, the uplink data component 1430 may be configured as or otherwise support a means for receiving respective portions of the second data packet via respective uplink shared channel transmission occasions of the second set of uplink shared channel transmission occasions.

In some examples, the starting symbol calculation component 1445 may be configured as or otherwise support a means for calculating a starting symbol associated with an uplink shared channel occasion of the first set of uplink shared channel transmission occasions or the second set of uplink shared channel transmission occasions in accordance with a dedicated range of SFN values, where the dedicated range of SFN values is a multiple of a duration of the first CG period or the second CG period, respectively.

In some examples, the starting symbol calculation component 1445 may be configured as or otherwise support a means for calculating a starting symbol associated with an uplink shared channel occasion of the first set of uplink shared channel transmission occasions or the second set of uplink shared channel transmission occasions in accordance with increasing or decreasing the starting symbol by a dedicated value each time an SFN resets from a maximum value to a minimum value, where the dedicated value is based on a modulo operation of the maximum value by a duration of the first CG period or the second CG period.

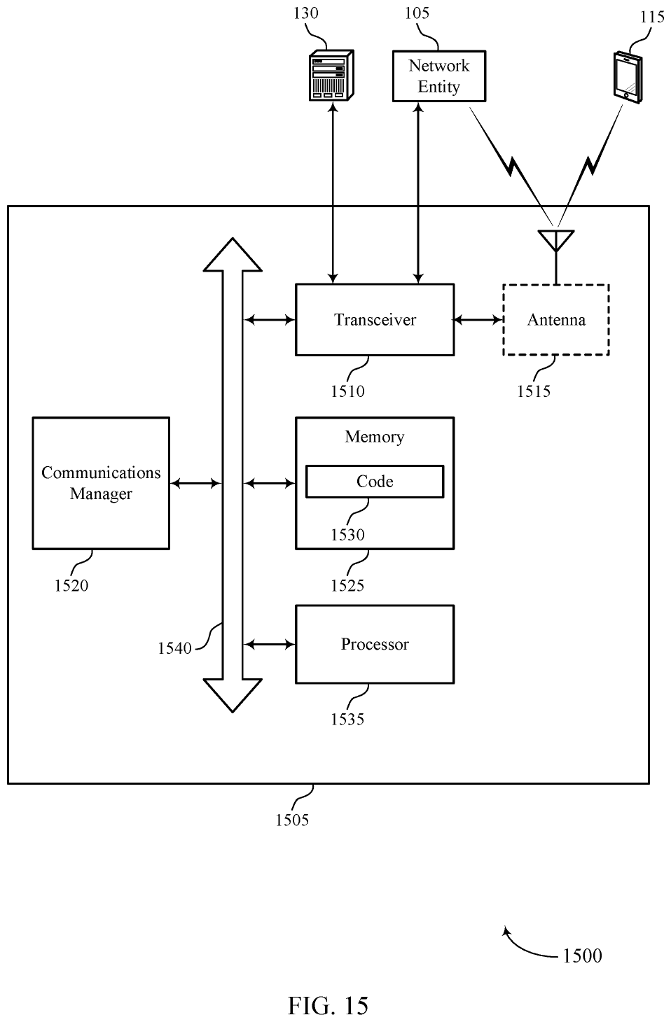

FIG. 15 illustrates a diagram of a system 1500 including a device 1505 that supports techniques for communicating uplink traffic via CG periods with multiple shared channel occasions in accordance with various aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals.

In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting techniques for communicating uplink traffic via CG periods with multiple shared channel occasions). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525).

In some implementations, the processor 1535 may be a component of a processing system. A processing system may refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both.

The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 may be configured as or otherwise support a means for transmitting control signaling associated with one or more uplink CGs usable by a UE, the one or more uplink CGs including a first set of uplink shared channel transmission occasions within a first CG period and a second set of uplink shared channel transmission occasions within a second CG period. The communications manager 1520 may be configured as or otherwise support a means for receiving, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of techniques for communicating uplink traffic via CG periods with multiple shared channel occasions as described herein, or the processor 1535 and the memory 1525 may be otherwise configured to perform or support such operations.

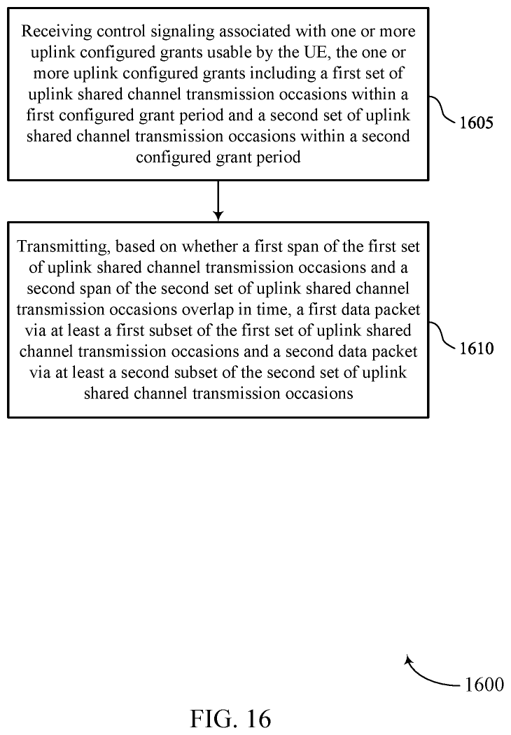

FIG. 16 illustrates a flowchart showing a method 1600 that supports techniques for communicating uplink traffic via CG periods with multiple shared channel occasions in accordance with various aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving control signaling associated with one or more uplink CGs usable by the UE, the one or more uplink CGs including a first set of uplink shared channel transmission occasions within a first CG period and a second set of uplink shared channel transmission occasions within a second CG period. The operations of 1605 may be performed in accordance with examples as disclosed herein. In some examples, aspects of the operations of 1605 may be performed by a CG configuration component 1025 as described with reference to FIG. 10.

At 1610, the method may include transmitting, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions. The operations of 1610 may be performed in accordance with examples as disclosed herein. In some examples, aspects of the operations of 1610 may be performed by an uplink data component 1030 as described with reference to FIG. 10.

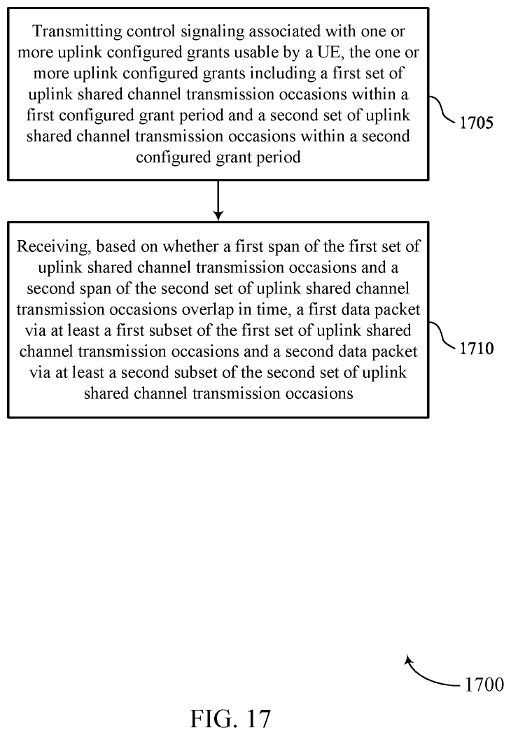

FIG. 17 illustrates a flowchart showing a method 1700 that supports techniques for communicating uplink traffic via CG periods with multiple shared channel occasions in accordance with various aspects of the present disclosure. The operations of the method 1700 may be implemented by a network entity or its components as described herein. For example, the operations of the method 1700 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1705, the method may include transmitting control signaling associated with one or more uplink CGs usable by a UE, the one or more uplink CGs including a first set of uplink shared channel transmission occasions within a first CG period and a second set of uplink shared channel transmission occasions within a second CG period. The operations of 1705 may be performed in accordance with examples as disclosed herein. In some examples, aspects of the operations of 1705 may be performed by a CG configuration component 1425 as described with reference to FIG. 14.

At 1710, the method may include receiving, based on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions. The operations of 1710 may be performed in accordance with examples as disclosed herein. In some examples, aspects of the operations of 1710 may be performed by an uplink data component 1430 as described with reference to FIG. 14.

Aspect 1: A method for wireless communication at a UE, comprising: receiving control signaling associated with one or more uplink CGs usable by the UE, the one or more uplink CGs including a first set of uplink shared channel transmission occasions within a first CG period and a second set of uplink shared channel transmission occasions within a second CG period; and transmitting, based at least in part on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

Aspect 2: The method of aspect 1, further comprising: receiving, via the control signaling, an indication of a first time domain resource allocation associated with the first set of uplink shared channel transmission occasions and a second time domain resource allocation associated with the second set of uplink shared channel transmission occasions, wherein the first span is associated with the first time domain resource allocation and the second span is associated with the second time domain resource allocation; and skipping an uplink shared channel transmission occasion of the first set of uplink shared channel transmission occasions in accordance with the uplink shared channel transmission occasion overlapping in time with the second span of the second set of uplink shared channel transmission occasions.

Aspect 3: The method of aspect 2, wherein skipping the uplink shared channel transmission occasion of the first set of uplink shared channel transmission occasions further comprises: skipping the uplink shared channel transmission occasion of the first set of uplink shared channel transmission occasions in accordance with the first span of the first set of uplink shared channel transmission occasions being associated with an earlier start time than the second span of the second set of uplink shared channel transmission occasions.

Aspect 4: The method of aspect 2, wherein skipping the uplink shared channel transmission occasion of the first set of uplink shared channel transmission occasions further comprises: skipping the uplink shared channel transmission occasion of the first set of uplink shared channel transmission occasions in accordance with the first span of the first set of uplink shared channel transmission occasions being associated with a later start time than the second span of the second set of uplink shared channel transmission occasions.

Aspect 5: The method of any of aspects 1 through 4, wherein receiving the control signaling further comprises: receiving information associated with the one or more uplink CGs in accordance with a time domain overlapping rule, wherein the time domain overlapping rule is indicative of an expectation that spans of sets of uplink shared channel transmission occasions within different CG periods avoid overlapping in time.

Aspect 6: The method of aspect 5, wherein the time domain overlapping rule is applied on a per-TRP basis.

Aspect 7: The method of any of aspects 1 through 6, wherein the first span is a time duration between a starting point of an initial uplink shared channel transmission occasion of the first set of uplink shared channel transmission occasions and an ending point of a final uplink shared channel transmission occasion of the first set of uplink shared channel transmission occasions, and the second span is a time duration between a starting point of an initial uplink shared channel transmission occasion of the second set of uplink shared channel transmission occasions and an ending point of a final uplink shared channel transmission occasion of the second set of uplink shared channel transmission occasions, and the first set of uplink shared channel transmission occasions is periodically available to the UE in accordance with the first CG period and the second set of uplink shared channel transmission occasions is periodically available to the UE in accordance with the second CG period.

Aspect 8: The method of any of aspects 1 through 7, wherein the first span and the second span are associated with a same CG.

Aspect 9: The method of any of aspects 1 through 7, wherein the first span and the second span are associated with different CGs.

Aspect 10: The method of any of aspects 1 through 9, wherein the first span includes all repetitions of uplink shared channel transmission occasions within the first CG period and the second span includes all repetitions of uplink shared channel transmission occasions within the second CG period.

Aspect 11: The method of any of aspects 1 through 7, 9, or 10, further comprising: receiving, via the control signaling, an indication that the first set of uplink shared channel transmission occasions is associated with a first CG and the second set of uplink shared channel transmission occasions is associated with a second CG, wherein the first CG period and the second CG period partially overlap to create an effective CG period shorter than each of the first CG period and the second CG period; generating the first data packet and the second data packet in accordance with the effective CG period; and transmitting the first data packet via the first set of uplink shared channel transmission occasions and the second data packet via the second set of uplink shared channel transmission occasions in accordance with the effective CG period.

Aspect 12: The method of aspect 11, wherein transmitting the first data packet and the second data packet further comprises: transmitting respective portions of the first data packet via respective uplink shared channel transmission occasions of the first set of uplink shared channel transmission occasions; and transmitting respective portions of the second data packet via respective uplink shared channel transmission occasions of the second set of uplink shared channel transmission occasions.

Aspect 13: The method of any of aspects 1 through 12, further comprising: calculating a starting symbol associated with an uplink shared channel occasion of the first set of uplink shared channel transmission occasions or the second set of uplink shared channel transmission occasions in accordance with a dedicated range of SFN values, wherein the dedicated range of SFN values is a multiple of a duration of the first CG period or the second CG period, respectively.

Aspect 14: The method of any of aspects 1 through 12, further comprising: calculating a starting symbol associated with an uplink shared channel occasion of the first set of uplink shared channel transmission occasions or the second set of uplink shared channel transmission occasions in accordance with increasing or decreasing the starting symbol by a dedicated value each time an SFN resets from a maximum value to a minimum value, wherein the dedicated value is based at least in part on a modulo operation of the maximum value by a duration of the first CG period or the second CG period.

Aspect 15: A method for wireless communication at a network entity, comprising: transmitting control signaling associated with one or more uplink CGs usable by a UE, the one or more uplink CGs including a first set of uplink shared channel transmission occasions within a first CG period and a second set of uplink shared channel transmission occasions within a second CG period; and receiving, based at least in part on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

Aspect 16: The method of aspect 15, further comprising: transmitting, via the control signaling, an indication of a first time domain resource allocation associated with the first set of uplink shared channel transmission occasions and a second time domain resource allocation associated with the second set of uplink shared channel transmission occasions, wherein the first span is associated with the first time domain resource allocation and the second span is associated with the second time domain resource allocation; and allocating, to a device different from the UE, an uplink shared channel transmission occasion of the first set of uplink shared channel transmission occasions in accordance with the uplink shared channel transmission occasion overlapping in time with the second span of the second set of uplink shared channel transmission occasions.

Aspect 17: The method of aspect 16, wherein allocating the uplink shared channel transmission occasion of the first set of uplink shared channel transmission occasions to the device different from the UE comprises: allocating the uplink shared channel transmission occasion of the first set of uplink shared channel transmission occasions in accordance with the first span of the first set of uplink shared channel transmission occasions being associated with an earlier start time than the second span of the second set of uplink shared channel transmission occasions.

Aspect 18: The method of aspect 16, wherein allocating the uplink shared channel transmission occasion of the first set of uplink shared channel transmission occasions to the device different from the UE comprises: allocating the uplink shared channel transmission occasion of the first set of uplink shared channel transmission occasions in accordance with the first span of the first set of uplink shared channel transmission occasions being associated with a later start time than the second span of the second set of uplink shared channel transmission occasions.

Aspect 19: The method of any of aspects 15 through 18, wherein transmitting the control signaling further comprises: transmitting information associated with the one or more uplink CGs in accordance with a time domain overlapping rule, wherein the time domain overlapping rule is indicative of an expectation that spans of sets of uplink shared channel transmission occasions within different CG periods avoid overlapping in time.

Aspect 20: The method of aspect 19, wherein the time domain overlapping rule is applied on a per-TRP basis.

Aspect 21: The method of any of aspects 15 through 20, wherein the first span is a time duration between a starting point of an initial uplink shared channel transmission occasion of the first set of uplink shared channel transmission occasions and an ending point of a final uplink shared channel transmission occasion of the first set of uplink shared channel transmission occasions, and the second span is a time duration between a starting point of an initial uplink shared channel transmission occasion of the second set of uplink shared channel transmission occasions and an ending point of a final uplink shared channel transmission occasion of the second set of uplink shared channel transmission occasions, and the first set of uplink shared channel transmission occasions is periodically available to the UE in accordance with the first CG period and the second set of uplink shared channel transmission occasions is periodically available to the UE in accordance with the second CG period.

Aspect 22: The method of any of aspects 15 through 21, wherein the first span and the second span are associated with a same CG.

Aspect 23: The method of any of aspects 15 through 21, wherein the first span and the second span are associated with different CGs.

Aspect 24: The method of any of aspects 15 through 23, wherein the first span includes all repetitions of uplink shared channel transmission occasions within the first CG period and the second span includes all repetitions of uplink shared channel transmission occasions within the second CG period.

Aspect 25: The method of any of aspects 15 through 21, 23, or 24, further comprising: transmitting, via the control signaling, an indication that the first set of uplink shared channel transmission occasions is associated with a first CG and the second set of uplink shared channel transmission occasions is associated with a second CG, wherein the first CG period and the second CG period partially overlap to create an effective CG period shorter than each of the first CG period and the second CG period, and wherein a duration of the effective CG period is based at least in part on a data generation frequency at the UE; and receiving the first data packet via the first set of uplink shared channel transmission occasions and the second data packet via the second set of uplink shared channel transmission occasions in accordance with the effective CG period.

Aspect 26: The method of aspect 25, wherein receiving the first data packet and the second data packet further comprises: receiving respective portions of the first data packet via respective uplink shared channel transmission occasions of the first set of uplink shared channel transmission occasions; and receiving respective portions of the second data packet via respective uplink shared channel transmission occasions of the second set of uplink shared channel transmission occasions.

Aspect 27: The method of any of aspects 15 through 26, further comprising: calculating a starting symbol associated with an uplink shared channel occasion of the first set of uplink shared channel transmission occasions or the second set of uplink shared channel transmission occasions in accordance with a dedicated range of SFN values, wherein the dedicated range of SFN values is a multiple of a duration of the first CG period or the second CG period, respectively.

Aspect 28: The method of any of aspects 15 through 26, further comprising: calculating a starting symbol associated with an uplink shared channel occasion of the first set of uplink shared channel transmission occasions or the second set of uplink shared channel transmission occasions in accordance with increasing or decreasing the starting symbol by a dedicated value each time an SFN resets from a maximum value to a minimum value, wherein the dedicated value is based at least in part on a modulo operation of the maximum value by a duration of the first CG period or the second CG period.

Aspect 29: An apparatus for wireless communication at a UE, comprising a processor; memory coupled with the processor; and instructions stored in the memory and executable by the processor to cause the apparatus to perform a method of any of aspects 1 through 14.

Aspect 30: An apparatus for wireless communication at a UE, comprising at least one means for performing a method of any of aspects 1 through 14.

Aspect 31: A non-transitory computer-readable medium storing code for wireless communication at a UE, the code comprising instructions executable by a processor to perform a method of any of aspects 1 through 14.

Aspect 32: An apparatus for wireless communication at a network entity, comprising a processor; memory coupled with the processor; and instructions stored in the memory and executable by the processor to cause the apparatus to perform a method of any of aspects 15 through 28.

Aspect 33: An apparatus for wireless communication at a network entity, comprising at least one means for performing a method of any of aspects 15 through 28.

Aspect 34: A non-transitory computer-readable medium storing code for wireless communication at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the present disclosure may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the present disclosure. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving control signaling associated with one or more uplink configured grants usable by the UE, the one or more uplink configured grants including a first set of uplink shared channel transmission occasions within a first configured grant period and a second set of uplink shared channel transmission occasions within a second configured grant period; and
transmitting, based at least in part on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

2. The method of claim 1, further comprising:
receiving, via the control signaling, an indication of a first time domain resource allocation associated with the first set of uplink shared channel transmission occasions and a second time domain resource allocation associated with the second set of uplink shared channel transmission occasions, wherein the first span is associated with the first time domain resource allocation and the second span is associated with the second time domain resource allocation; and
skipping an uplink shared channel transmission occasion of the first set of uplink shared channel transmission occasions in accordance with the uplink shared channel transmission occasion overlapping in time with the second span of the second set of uplink shared channel transmission occasions.

3. The method of claim 2, wherein skipping the uplink shared channel transmission occasion of the first set of uplink shared channel transmission occasions further comprises:
skipping the uplink shared channel transmission occasion of the first set of uplink shared channel transmission occasions in accordance with the first span of the first set of uplink shared channel transmission occasions being associated with an earlier start time than the second span of the second set of uplink shared channel transmission occasions.

4. The method of claim 2, wherein skipping the uplink shared channel transmission occasion of the first set of uplink shared channel transmission occasions further comprises:
skipping the uplink shared channel transmission occasion of the first set of uplink shared channel transmission occasions in accordance with the first span of the first set of uplink shared channel transmission occasions being associated with a later start time than the second span of the second set of uplink shared channel transmission occasions.

5. The method of claim 1, wherein receiving the control signaling further comprises:
receiving information associated with the one or more uplink configured grants in accordance with a time domain overlapping rule, wherein the time domain overlapping rule is indicative of an expectation that spans of sets of uplink shared channel transmission occasions within different configured grant periods avoid overlapping in time.

6. The method of claim 5, wherein the time domain overlapping rule is applied on a per-transmission and reception point (TRP) basis.

7. The method of claim 1, wherein the first span is a time duration between a starting point of an initial uplink shared channel transmission occasion of the first set of uplink shared channel transmission occasions and an ending point of a final uplink shared channel transmission occasion of the first set of uplink shared channel transmission occasions, and the second span is a time duration between a starting point of an initial uplink shared channel transmission occasion of the second set of uplink shared channel transmission occasions and an ending point of a final uplink shared channel transmission occasion of the second set of uplink shared channel transmission occasions, and wherein the first set of uplink shared channel transmission occasions is periodically available to the UE in accordance with the first configured grant period and the second set of uplink shared channel transmission occasions is periodically available to the UE in accordance with the second configured grant period.

8. The method of claim 1, wherein the first span and the second span are associated with a same configured grant.

9. The method of claim 1, wherein the first span and the second span are associated with different configured grants.

10. The method of claim 1, wherein the first span includes all repetitions of uplink shared channel transmission occasions within the first configured grant period and the second span includes all repetitions of uplink shared channel transmission occasions within the second configured grant period.

11. The method of claim 1, further comprising:
receiving, via the control signaling, an indication that the first set of uplink shared channel transmission occasions is associated with a first configured grant and the second set of uplink shared channel transmission occasions is associated with a second configured grant, wherein the first configured grant period and the second configured grant period partially overlap to create an effective configured grant period shorter than each of the first configured grant period and the second configured grant period;
generating the first data packet and the second data packet in accordance with the effective configured grant period; and
transmitting the first data packet via the first set of uplink shared channel transmission occasions and the second data packet via the second set of uplink shared channel transmission occasions in accordance with the effective configured grant period.

12. The method of claim 11, wherein transmitting the first data packet and the second data packet further comprises:
transmitting respective portions of the first data packet via respective uplink shared channel transmission occasions of the first set of uplink shared channel transmission occasions; and
transmitting respective portions of the second data packet via respective uplink shared channel transmission occasions of the second set of uplink shared channel transmission occasions.

13. The method of claim 1, further comprising:
calculating a starting symbol associated with an uplink shared channel occasion of the first set of uplink shared channel transmission occasions or the second set of uplink shared channel transmission occasions in accordance with a dedicated range of system frame number values, wherein the dedicated range of system frame number values is a multiple of a duration of the first configured grant period or the second configured grant period, respectively.

14. The method of claim 1, further comprising:
calculating a starting symbol associated with an uplink shared channel occasion of the first set of uplink shared channel transmission occasions or the second set of uplink shared channel transmission occasions in accordance with increasing or decreasing the starting symbol by a dedicated value each time a system frame number resets from a maximum value to a minimum value, wherein the dedicated value is based at least in part on a modulo operation of the maximum value by a duration of the first configured grant period or the second configured grant period.

15. A method for wireless communication at a network entity, comprising:
transmitting control signaling associated with one or more uplink configured grants usable by a user equipment (UE), the one or more uplink configured grants including a first set of uplink shared channel transmission occasions within a first configured grant period and a second set of uplink shared channel transmission occasions within a second configured grant period; and
receiving, based at least in part on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

16. The method of claim 15, further comprising:
transmitting, via the control signaling, an indication of a first time domain resource allocation associated with the first set of uplink shared channel transmission occasions and a second time domain resource allocation associated with the second set of uplink shared channel transmission occasions, wherein the first span is associated with the first time domain resource allocation and the second span is associated with the second time domain resource allocation; and
allocating, to a device different from the UE, an uplink shared channel transmission occasion of the first set of uplink shared channel transmission occasions in accordance with the uplink shared channel transmission occasion overlapping in time with the second span of the second set of uplink shared channel transmission occasions.

17. The method of claim 16, wherein allocating the uplink shared channel transmission occasion of the first set of uplink shared channel transmission occasions to the device different from the UE comprises:
allocating the uplink shared channel transmission occasion of the first set of uplink shared channel transmission occasions in accordance with the first span of the first set of uplink shared channel transmission occasions being associated with an earlier start time than the second span of the second set of uplink shared channel transmission occasions.

18. The method of claim 16, wherein allocating the uplink shared channel transmission occasion of the first set of uplink shared channel transmission occasions to the device different from the UE comprises:
allocating the uplink shared channel transmission occasion of the first set of uplink shared channel transmission occasions in accordance with the first span of the first set of uplink shared channel transmission occasions being associated with a later start time than the second span of the second set of uplink shared channel transmission occasions.

19. The method of claim 15, wherein transmitting the control signaling further comprises:
transmitting information associated with the one or more uplink configured grants in accordance with a time domain overlapping rule, wherein the time domain overlapping rule is indicative of an expectation that spans of sets of uplink shared channel transmission occasions within different configured grant periods avoid overlapping in time.

20. An apparatus for wireless communication at a user equipment (UE), comprising:
a processor;
memory coupled with the processor; and
instructions stored in the memory and executable by the processor to cause the apparatus to:
receive control signaling associated with one or more uplink configured grants usable by the UE, the one or more uplink configured grants including a first set of uplink shared channel transmission occasions within a first configured grant period and a second set of uplink shared channel transmission occasions within a second configured grant period; and
transmit, based at least in part on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

21. The apparatus of claim 20, wherein the instructions are further executable by the processor to cause the apparatus to:
receive, via the control signaling, an indication of a first time domain resource allocation associated with the first set of uplink shared channel transmission occasions and a second time domain resource allocation associated with the second set of uplink shared channel transmission occasions, wherein the first span is associated with the first time domain resource allocation and the second span is associated with the second time domain resource allocation; and
skip an uplink shared channel transmission occasion of the first set of uplink shared channel transmission occasions in accordance with the uplink shared channel transmission occasion overlapping in time with the second span of the second set of uplink shared channel transmission occasions.

22. The apparatus of claim 20, wherein the instructions to receive the control signaling are further executable by the processor to cause the apparatus to:
receive information associated with the one or more uplink configured grants in accordance with a time domain overlapping rule, wherein the time domain overlapping rule is indicative of an expectation that spans of sets of uplink shared channel transmission occasions within different configured grant periods avoid overlapping in time.

23. The apparatus of claim 20, wherein the instructions are further executable by the processor to cause the apparatus to:
receive, via the control signaling, an indication that the first set of uplink shared channel transmission occasions is associated with a first configured grant and the second set of uplink shared channel transmission occasions is associated with a second configured grant, wherein the first configured grant period and the second configured grant period partially overlap to create an effective configured grant period shorter than each of the first configured grant period and the second configured grant period;
generate the first data packet and the second data packet in accordance with the effective configured grant period; and
transmit the first data packet via the first set of uplink shared channel transmission occasions and the second data packet via the second set of uplink shared channel transmission occasions in accordance with the effective configured grant period.

24. The apparatus of claim 20, wherein the instructions are further executable by the processor to cause the apparatus to:
calculate a starting symbol associated with an uplink shared channel occasion of the first set of uplink shared channel transmission occasions or the second set of uplink shared channel transmission occasions in accordance with a dedicated range of system frame number values, wherein the dedicated range of system frame number values is a multiple of a duration of the first configured grant period or the second configured grant period, respectively.

25. The apparatus of claim 20, wherein the instructions are further executable by the processor to cause the apparatus to:
calculate a starting symbol associated with an uplink shared channel occasion of the first set of uplink shared channel transmission occasions or the second set of uplink shared channel transmission occasions in accordance with increasing or decreasing the starting symbol by a dedicated value each time a system frame number resets from a maximum value to a minimum value, wherein the dedicated value is based at least in part on a modulo operation of the maximum value by a duration of the first configured grant period or the second configured grant period.

26. An apparatus for wireless communication at a network entity, comprising:
a processor;
memory coupled with the processor; and
instructions stored in the memory and executable by the processor to cause the apparatus to:
transmit control signaling associated with one or more uplink configured grants usable by a user equipment (UE), the one or more uplink configured grants including a first set of uplink shared channel transmission occasions within a first configured grant period and a second set of uplink shared channel transmission occasions within a second configured grant period; and
receive, based at least in part on whether a first span of the first set of uplink shared channel transmission occasions and a second span of the second set of uplink shared channel transmission occasions overlap in time, a first data packet via at least a first subset of the first set of uplink shared channel transmission occasions and a second data packet via at least a second subset of the second set of uplink shared channel transmission occasions.

27. The apparatus of claim 26, wherein the instructions are further executable by the processor to cause the apparatus to:
transmit, via the control signaling, an indication of a first time domain resource allocation associated with the first set of uplink shared channel transmission occasions and a second time domain resource allocation associated with the second set of uplink shared channel transmission occasions, wherein the first span is associated with the first time domain resource allocation and the second span is associated with the second time domain resource allocation; and
allocate, to a device different from the UE, an uplink shared channel transmission occasion of the first set of uplink shared channel transmission occasions in accordance with the uplink shared channel transmission occasion overlapping in time with the second span of the second set of uplink shared channel transmission occasions.

28. The apparatus of claim 26, wherein the instructions are further executable by the processor to cause the apparatus to:
transmit, via the control signaling, an indication that the first set of uplink shared channel transmission occasions is associated with a first configured grant and the second set of uplink shared channel transmission occasions is associated with a second configured grant, wherein the first configured grant period and the second configured grant period partially overlap to create an effective configured grant period shorter than each of the first configured grant period and the second configured grant period, and wherein a duration of the effective configured grant period is based at least in part on a data generation frequency at the UE; and
receive the first data packet via the first set of uplink shared channel transmission occasions and the second data packet via the second set of uplink shared channel transmission occasions in accordance with the effective configured grant period.

29. The apparatus of claim 26, wherein the instructions are further executable by the processor to cause the apparatus to:
calculate a starting symbol associated with an uplink shared channel occasion of the first set of uplink shared channel transmission occasions or the second set of uplink shared channel transmission occasions in accordance with a dedicated range of system frame number values, wherein the dedicated range of system frame number values is a multiple of a duration of the first configured grant period or the second configured grant period, respectively.

30. The apparatus of claim 26, wherein the instructions are further executable by the processor to cause the apparatus to:
calculate a starting symbol associated with an uplink shared channel occasion of the first set of uplink shared channel transmission occasions or the second set of uplink shared channel transmission occasions in accordance with increasing or decreasing the starting symbol by a dedicated value each time a system frame number resets from a maximum value to a minimum value, wherein the dedicated value is based at least in part on a modulo operation of the maximum value by a duration of the first configured grant period or the second configured grant period.
